(19) United States
(12) Patent Application Publication
(10) Pub. No.: US 2020/0053357 A1
(43) Pub. Date: Feb. 13, 2020

(54) ENCODER AND METHOD FOR ENCODING

(71) Applicant: FUJITSU LIMITED, Kawasaki-shi (JP)

(72) Inventors: XUYING LEI, Kawasaki (JP); Hidenobu MIYOSHI, Kawasaki (JP)

(73) Assignee: FUJITSU LIMITED, Kawasaki-shi (JP)

(21) Appl. No.: 16/516,468

(22) Filed: Jul. 19, 2019

(30) Foreign Application Priority Data
Aug. 13, 2018 (JP) 2018-152392

(51) Int. Cl. H04N 19/105; H04N 19/174; H04N 19/124; H04N 19/176

(52) U.S. Cl. CPC H04N 19/105; H04N 19/176; H04N 19/124; H04N 19/174

(57) ABSTRACT

An encoder includes: a plurality of first processors; and a second processor configured to: generate reduced image information by reducing image information; determine that a first block is a preferential object block when it is determined, based on a direction of a motion vector of the first block, that the first block is a block to be encoded with reference to a block included in a second reduced slice adjacent to a first reduced slice among reduced slices obtained by dividing the reduced image information, the first block being included in the first reduced slice; and perform, when the first block is a preferential object block, a control to reduce a first quantization parameter used by one of the plurality of first processors to encode a block corresponding to the first block among a plurality of blocks included in a first slice corresponding to the first reduced slice.

### CROSS-REFERENCE TO RELATED APPLICATION

This application is based upon and claims the benefit of priority of the prior Japanese Patent Application No. 2018-152392, filed on Aug. 13, 2018, the entire contents of which are incorporated herein by reference.

### FIELD

The embodiments discussed herein are related to an encoder and a method for encoding.

### BACKGROUND

The latest video coding scheme HEVC (High Efficiency Video Coding) achieves a compression performance which is twice the compression performance of H.264 that has been generally distributed currently. With the broadcast industry as a major player, the HEVC has begun to be introduced as a technology that is capable of efficiently compressing an ultra-high definition video having a huge amount of data (4K/8K) and reducing the network traffics. Since the HEVC had already been adopted for the 4K/8K broadcasting, 4K/8K test broadcasting had started in 2016 and a practical broadcasting had started in 2018. As for the domestic broadcast applications in Japan, ARIB STD-B32 is defined in ARIB (Association of Radio Industries and Businesses).

In terms of resolution, 8K is 16 times higher than HD (High Definition). In addition, 8K has features such as a wide color gamut that may express the colors of the natural world as close as possible to the real thing, a high frame rate that captures fast movements smoothly, and a high dynamic range that may clearly express the brightness and the darkness. Due to these features, the 4K/8K ultra-high definition technology is also expected to be used outside the broadcasting area. For example, an effective utilization in the fields of advertising and design, crime prevention, implementation of ultra-high definition systems in the surveillance field, meetings, and presentations are expected. In addition, films, entertainments, educations, and academic fields are assumed, but along with these, there are strong expectations for an application to the medical field. Therefore, there is an increasing need to compress the 8K video at a practical rate.

Since the amount of data of the 8K video is huge, it is difficult to encode with a single device. For this reason, there is a space-time parallel processing technology as a method of reducing the processing load in the case of 8K. The space-time parallel processing technology is a technology in which a video to be encoded is divided into the temporal direction and the space direction, and a parallel processing is performed by a plurality of devices.

FIG. 32 is a view for explaining an example of the space-time parallel processing. As illustrated in FIG. 32, in this example, one picture 10 is divided into four slices 0 to 3. For example, the horizontal width of the picture 10 is 7680 pixels, and the vertical width thereof is 4320 lines. The vertical width of each of the slices 0 to 3 is 1088 lines. In this example, the slices 0 to 3 are respectively input to four devices (not illustrated) to encode 8K images in parallel.

When encoding is performed by a plurality of devices as in this example, reference pictures are not shared between devices in a viewpoint of data transfer amount. Therefore, when an inter prediction or an intra prediction is performed in a block near a slice boundary, a reference across slices may not be performed, and the image quality is deteriorated at the slice boundary.

FIG. 33 is a view for explaining a problem of deterioration of image quality at the slice boundary. In the example illustrated in FIG. 33, a picture to be encoded is a picture 11a, and a reference picture of the picture 11a is a picture 11b. Although not illustrated, it is assumed that a device D0 stores and encodes a slice 0, and a device D1 stores and encodes a slice 1.

Here, a case where the device D0 encodes a block 12a of the picture 11a will be described. For example, when a block to be referred to when encoding the block 12a is a block 13a, the block 13a is included in the slice 0. Therefore, the device D0 may refer to the block 13a when encoding the block 12a, and the image quality is not deteriorated at the slice boundary.

In the meantime, when the block to be referred to when encoding the block 12a is a block 13b or a block 13c, since the slice D1 is not stored in the device D0, the device D0 may not refer to the blocks 13b and 13c. In this manner, when the device D0 is not able to refer to the blocks 13b and 13c, the encoding of the block 12a may not be optimally performed. Therefore, the image quality is deteriorated when a picture including the block 12a is decoded and reproduced.

For example, as the block 12a in FIG. 33 is not able to refer to the block 13b or 13c, a horizontal line may appear at the boundary between the slice 0 and the slice 1 in the picture 11a. In addition, when a horizontal line has already appeared in the picture 11b, in a time hierarchical encoding, since encoding is performed with reference to the positions where the pictures of the L4 layer are shifted vertically one after another, deterioration of the boundary is propagated, and a plurality of horizontal lines appear in the picture 11a.

There are a related art 1 and a related art 2 as related arts for reducing the image quality deterioration at the slice boundary described in FIG. 33. In the related art 1, in order to more finely quantize a macro block located at the slice boundary, a processing is performed to newly set a smaller quantization parameter. By reducing the quantization parameter, the image quality at the slice boundary may be improved. In the prior art 2, by adaptively switching an M value (the number of pictures in one SOP) according to the speed of motion, it is possible to avoid as much as possible a situation where an optimal motion vector near the slice boundary may not be selected due to a motion vector restriction, which may reduce the possibility of image quality deterioration at a division boundary.

Related techniques are disclosed in, for example, Japanese Laid-open Patent Publication No. 2004-235683 and Japanese Laid-open Patent Publication No. 2018-014750.

Related techniques are also disclosed in, for example, VIDEO CODING, AUDIO CODING, AND MULTIPLEXING SPECIFICATIONS FOR DIGITAL BROADCASTING ARIB STANDARD ARIB STD-B32 VERSION 3.9-E1, Association of Radio Industries and Businesses, December 2016.

However, the above-described related arts have a problem that a boundary deterioration in a spatial parallel processing may not be improved.

When encoding a picture, since the upper limit of the amount of data to be allocated to a single picture is determined in view of the amount of data transfer, it is preferable that the amount of data to be allocated to a complex part of the picture area is made larger. In the meantime, in the related art 1 described above, without being limited to a scene, since the quantization parameter at the slice boundary is reduced and the amount of data allocated to a block at the slice boundary is increased, images of the overall picture are deteriorated. For example, in FIG. 33, when a block referred to by the block 12a is the block 13a, allocating a large amount of data to the encoding of the block 12a is not an appropriate response.

### SUMMARY

According to an aspect of the embodiments, an encoder includes: a plurality of first processors each configured to encode one of a plurality of slices obtained by dividing image information; and a second processor configured to: generate reduced image information by reducing the image information; determine that a first block is a preferential object block when it is determined, based on a direction of a motion vector of the first block, that the first block is a block to be encoded with reference to a block included in a second reduced slice adjacent to a first reduced slice among a plurality of reduced slices obtained by dividing the reduced image information, the first block being included in the first reduced slice; and perform, when it is determined that the first block is a preferential object block, a control to reduce a first quantization parameter used by one of the plurality of first processors to encode a block corresponding to the first block among a plurality of blocks included in a first slice corresponding to the first reduced slice.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a view illustrating the configuration of a system according to a first embodiment;

FIG. 2 is a view illustrating the configuration of an encoding device according to the first embodiment;

FIG. 3 is a view for explaining a processing of a dividing unit according to the first embodiment;

FIG. 4 is a view for explaining a processing of a reduced image encoding unit according to the first embodiment;

FIG. 5 is a view for explaining statistical information;

FIG. 6 is a view (1) for explaining a processing for a block located at a lower end of a reduced slice;

FIG. 7 is a view (2) for explaining a processing for the block located at the lower end of the reduced slice;

FIG. 8 is a view (1) for explaining a processing for a block located at an upper end of the reduced slice;

FIG. 9 is a view (2) for explaining a processing for the block located at the upper end of the reduced slice;

FIG. 10 is a view for explaining a processing of determining a range of image deterioration;

FIG. 11 is a view for explaining the order of encoding by an intra prediction;

FIG. 12 is a view illustrating an example of generating a predicted image of an encoding target block using two intra prediction modes;

FIG. 13 is a view for explaining a processing of a determination unit when an encoding mode is an intra prediction;

FIG. 14 is a view illustrating a correspondence between blocks on reduced image information and blocks on image information;

FIG. 15 is a functional block diagram illustrating the configuration of a reduced image encoding unit according to the first embodiment;

FIG. 16 is a functional block diagram of the configuration of an encoding unit according to the first embodiment;

FIG. 17 is a flowchart illustrating the processing procedure of the encoding device according to the first embodiment;

FIG. 18 is a flowchart illustrating a processing of encoding reduced image information according to the first embodiment;

FIG. 19 is a flowchart illustrating a processing of encoding a slice according to the first embodiment;

FIG. 20 is a view illustrating classification of intra prediction directions;

FIG. 21 is a view (1) for explaining a processing of an encoding device according to a second embodiment;

FIG. 22 is a view (2) illustrating a processing of the encoding device according to the second embodiment;

FIG. 23 is a view illustrating the configuration of the encoding device according to the second embodiment;

FIG. 24 is a view defining each line of each slice;

FIG. 25 is a flowchart illustrating the processing procedure of the encoding device according to the second embodiment;

FIG. 26 is a view (1) for explaining a processing of an encoding device according to a third embodiment;

FIG. 27 is a view (2) illustrating a processing of the encoding device according to the third embodiment;

FIG. 28 is a view illustrating the configuration of the encoding device according to the third embodiment;

FIG. 29 is a flowchart illustrating the processing procedure of the encoding device according to the third embodiment;

FIG. 30 is a view for explaining other processing of the reduced image encoding unit;

FIG. 31 is a view for describing other processing of the encoding device;

FIG. 32 is a view for explaining an example of a space-time parallel processing; and

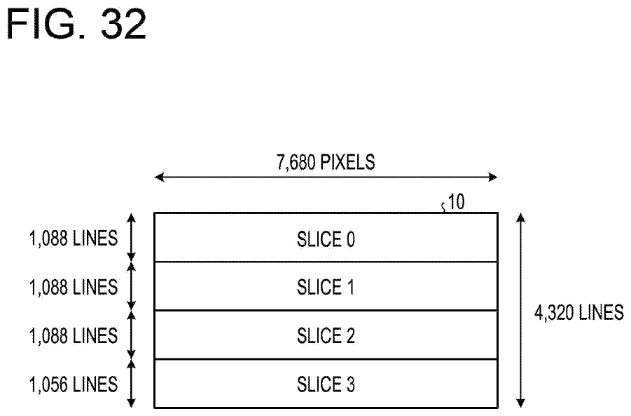

FIG. 33 is a view for explaining a problem of deterioration of image quality at the slice boundary.

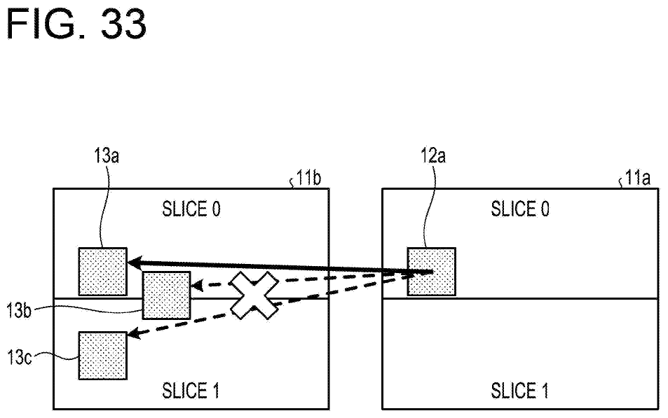

### DESCRIPTION OF EMBODIMENTS

Hereinafter, embodiments will be described in detail with reference to the accompanying drawings. The present disclosure is not limited by these embodiments.

### First Embodiment

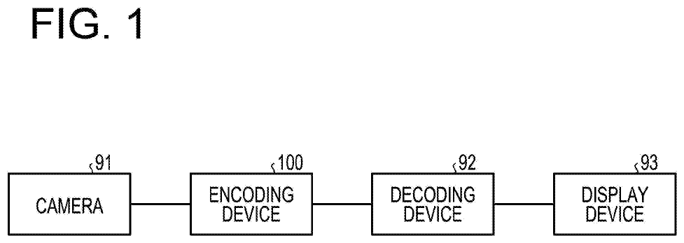

FIG. 1 is a view illustrating the configuration of a system according to a first embodiment. As illustrated in FIG. 1, the system includes a camera 91, an encoding device 100 (or encoder), a decoding device 92, and a display device 93. The camera 91 and the encoding device 100 are interconnected. The encoding device 100 and the decoding device 92 are interconnected. The decoding device 92 and the display device 93 are interconnected.

The camera 91 is a camera that captures a video. The camera 91 transmits information of the captured video to the encoding device 100. It is assumed that the video information includes a plurality of pictures (image information).

The encoding device 100 is a device that generates stream information by Entropy-encoding the video information received from the camera 10. The encoding device 100 transmits the stream information to the decoding device 92.

Here, the encoding device 100 includes a plurality of encoding units. The encoding device 100 divides the video information into a plurality of slices in the vertical direction, assigns one slice to a single encoding unit, and performs an encoding processing in parallel. In addition, the encoding device 100 generates reduced image information which is obtained by reducing the image information.

When a first block included in a first reduced slice among a plurality of reduced slices obtained by dividing the reduced image information into slices is a block that is encoded by referring to a block included in a second reduced slice adjacent to the first reduced slice based on the direction of a motion vector of the first block, the encoding device 100 determines the first block as a preferential object block.

When determining the first block as a preferential object block, the encoding device 100 performs a control such that an encoding unit which encodes a slice corresponding to the first reduced slice reduces a quantization parameter when encoding a block corresponding to the first block (the preferential object block) among a plurality of blocks included in the slice.

In this manner, the encoding device 100 identifies a block having a reduced quantization parameter among blocks included in a slice of the image information based on a plurality of reduced slices obtained by slicing the reduced image information. This may improve a boundary deterioration in the spatial parallel processing. In addition, since the encoding device 100 performs a control to reduce the quantization parameter for the identified block without performing a control to reduce the quantization parameters for all blocks located at the slice boundary, the amount of data to be allocated to the slice boundary may be saved, so that the deterioration of images may be suppressed throughout the entire picture.

The decoding device 92 receives the stream information from the encoding device 100 and decodes the received stream information to generate a video. The decoding device 92 outputs video information to the display device 93.

The display device 93 receives the video information from the decoding device 92 and displays the video. For example, the display device 93 corresponds to a liquid crystal display, a touch panel, a television monitor, or the like.

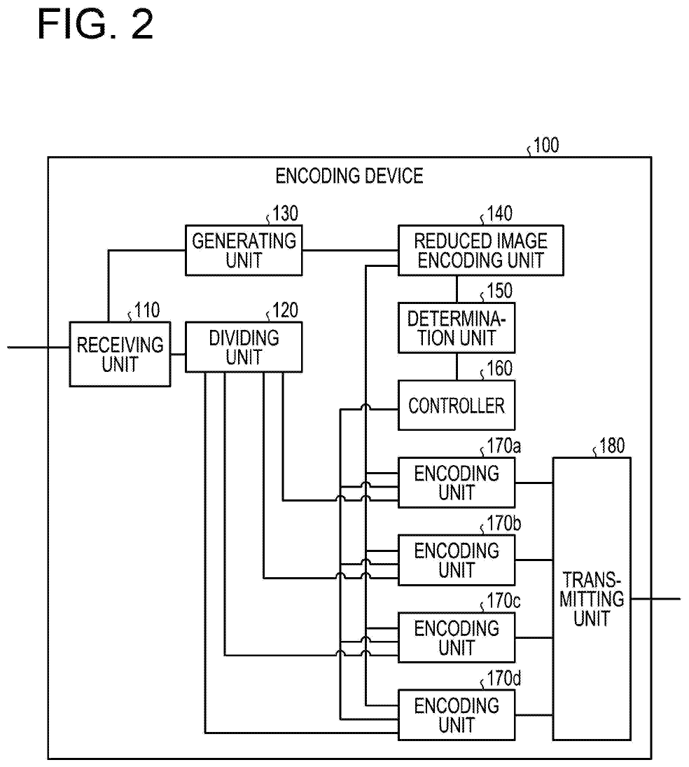

Next, an example of a processing of the encoding device 100 according to the first embodiment will be described. FIG. 2 is a view illustrating the configuration of the encoding device according to the first embodiment. As illustrated in FIG. 2, the encoding device 100 includes a receiving unit 110, a dividing unit 120, a generating unit 130, a reduced image encoding unit 140, a determination unit 150, and a controller 160. The encoding device 100 further includes encoding units 170a, 170b, 170c, and 170d and a transmitting unit 180.

The receiving unit 110 is a processing unit that receives the video information from the camera 91. The receiving unit outputs the image information (picture) included in the video information to the dividing unit 120 and the generating unit 130.

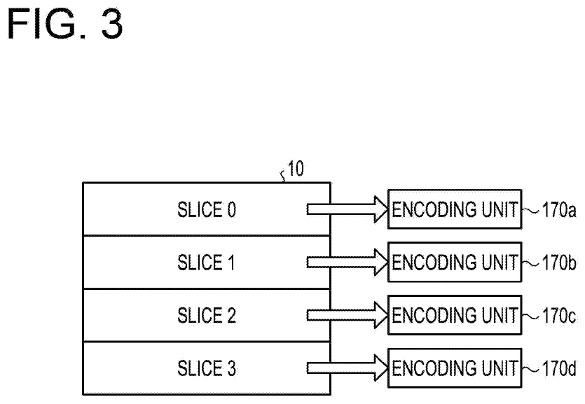

The dividing unit 120 is a processing unit that divides the image information into a plurality of slices and outputs the divided slices to the encoding units 170a, 170b, 170c, and 170d. FIG. 3 is a view for explaining a processing of the dividing unit according to the first embodiment. As illustrated in FIG. 3, the dividing unit 120 divides a picture 10 into four slices 0 to 3. The dividing unit 120 outputs the slice 0 to the encoding unit 170a. The dividing unit 120 outputs the slice 1 to the encoding unit 170b. The dividing unit 120 outputs the slice 2 to the encoding unit 170c. The dividing unit 120 outputs the slice 3 to the encoding unit 170d. The dividing unit 120 repeatedly executes the above processing on each of the image information.

The generating unit 130 is a processing unit that generates reduced image information by reducing the image information to an image size that may be processed by a single encoder (e.g., the reduced image encoding unit 140). It is assumed that the size of the image information is n pixels in the horizontal direction and m pixels in the vertical direction. The reduction ratio in the horizontal direction is assumed to be d1, and the reduction ratio in the vertical direction is assumed to be d2. In this case, the generating unit 130 generates reduced image information of n×d1 pixels in the horizontal direction and m×d2 pixels in the vertical direction. The reduction ratios d1 and d2 are positive values of 1 or less. For example, it is assumed that the values of the reduction ratios d1 and d2 are ½.

For example, the generating unit 130 applies a smoothing filter such as a Gaussian filter or an averaging filter to each pixel of the image information received from the receiving unit 110 to smooth the image information. The generating unit 130 generates reduced image information by subsampling the smoothed image information in accordance with the reduction ratios in the horizontal direction and the vertical direction. The generating unit 130 outputs the reduced image information to the reduced image encoding unit 140.

The reduced image encoding unit 140 is a processing unit that divides the reduced image information into a plurality of slices by the same dividing method as the dividing unit 120 and encodes each slice. The reduced image information may be divided into a plurality of slices in advance by the generating unit 130. In the following description, a slice of the reduced image information is referred to as a “reduced slice”, and a slice of the image information is referred to as a “slice”.

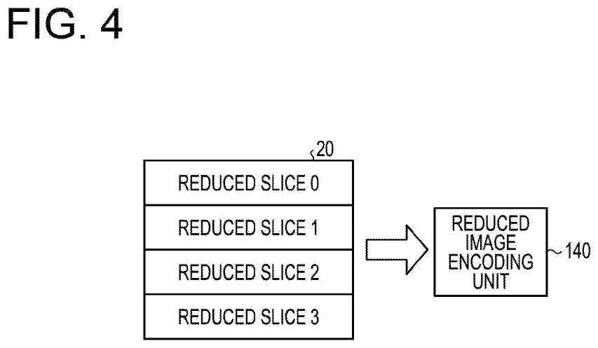

FIG. 4 is a view for explaining a processing of the reduced image encoding unit according to the first embodiment. As illustrated in FIG. 4, the reduced image encoding unit 140 divides the reduced image information 20 into four reduced slices 0 to 3 and encodes the reduced slices 0 to 3.

When encoding the reduced slices 0 to 3, the reduced image encoding unit 140 generates statistical information and stores the statistical information in a storage area of the determination unit 150. The statistical information includes information such as a motion vector of a block located at the reduced slice boundary.

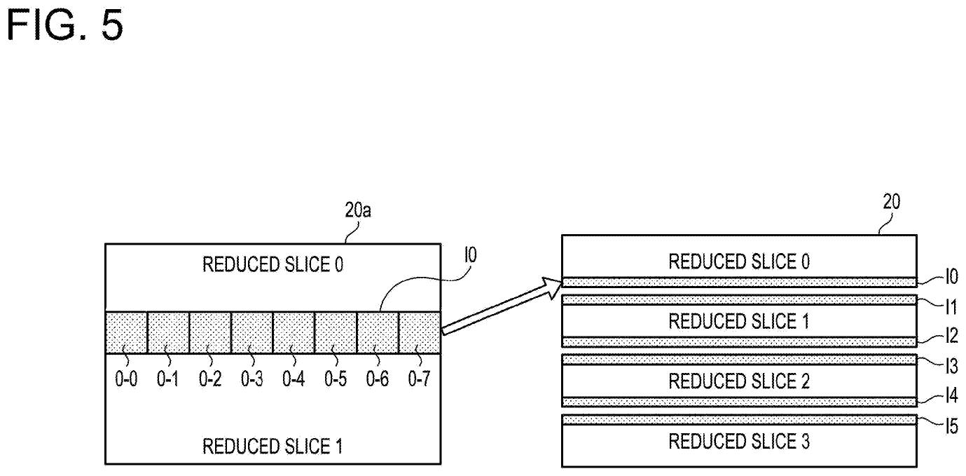

FIG. 5 is a view for explaining the statistical information. As illustrated in FIG. 5, in the case where four reduced slices are included in the reduced image information 20, six lines are included. For example, the reduced slice 0 includes a line l0 located at the boundary with the reduced slice 1. The reduced slice 1 includes a line l1 located at the boundary with the reduced slice 0 and a line l2 located at the boundary with the reduced slice 2. The reduced slice 2 includes a line l3 located at the boundary with the reduced slice 1 and a line l4 located at the boundary with the reduced slice 3. The reduced slice 3 includes a line l5 located at the boundary with the reduced slice 2.

An image 20a more specifically illustrates the line l0 included in the reduced slice 0. For example, the reduced slice 0 has a plurality of blocks 0-0 to 0-7. The blocks 0-0 to 0-7 are illustrated for convenience, and the reduced slice 0 may include other blocks. For example, the blocks in the first embodiment correspond to CTBs (coding tree blocks).

When a block includes an inter prediction block, the reduced image encoding unit 140 generates motion vector information 1A and 1B, and stores such information in a storage area of the determination unit 150. The motion vector information 1A stores a value of the vertical component of a motion vector of a block when the prediction direction is a forward direction. When the block includes a plurality of inter prediction blocks, the vertical average value of motion vectors is stored. The motion vector information 1B stores a value of the vertical component of a motion vector of a block when the prediction direction is a backward direction. When the block includes a plurality of inter prediction blocks, the vertical average value of motion vectors is stored.

MV_Ver_L0[i][j][k] (1A)

MV_Ver_L1[i][j][k] (1B)

The symbol “i” represented in the motion vector information 1A and 1B indicates the position of a line in which a block is contained. For example, when the line of the block is the line l0 illustrated in FIG. 5, “0” is set to i. When the line of the block is the line l1 to l5, “1 to 5” is set to i. The symbol “j” indicates the direction of the vertical component of a motion vector. When the vertical component of the motion vector is greater than 0, “0” is set to j. When the vertical component of the motion vector is smaller than 0, “1” is set to j. The symbol “k” indicates the number of a block in the horizontal direction, with the top as the 0th. For example, when an object block is the block 0-0, “0” is set to k. When the object block is the block 0-1, “1” is set to k.

When a block includes an intra prediction block, the reduced image encoding unit 140 generates motion vector information 1C and stores such information in a storage area of the determination unit 150. The reduced image encoding unit 140 stores an average value in the prediction direction when all the CUs (coding units) included in one block are intra prediction.

IntraPredMode[i][k] (1C)

The symbol “i” represented in the motion vector information 1C indicates the position of a line in which a block is contained. For example, when the line of the block is the line l0 illustrated in FIG. 5, “0” is set to i. The symbol “k” indicates the number of a block in the horizontal direction, with the top as the 0th. For example, when an object block is the block 0-0, “0” is set to k. When the object block is the block 0-1, “1” is set to k.

The determination unit 150 is a processing unit that determines a block to be treated as a preferential object, based on the statistical information stored in the storage area. The determination unit 150 determines whether an image quality deterioration occurs at the slice boundary according to the direction of a motion vector of a block included in the statistical information, and determines a range of the image quality deterioration according to the size of the motion vector. A block included in the range of image quality deterioration is the preferential object block. The determination unit 150 outputs the determination result to the controller 160.

The determination unit 150 performs a processing on a block basis. The processing of the determination unit 150 differs depending on whether an encoding mode of a block to be processed is an “inter prediction” or an “intra prediction”.

Descriptions will be made on the processing of the determination unit 150 when the encoding mode of the block to be processed is the inter prediction. First, the determination unit 150 determines whether the image quality deterioration occurs at the slice boundary according to the direction of a motion vector.

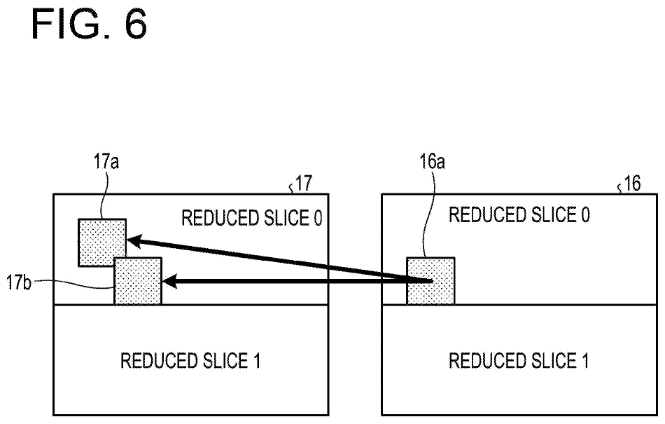

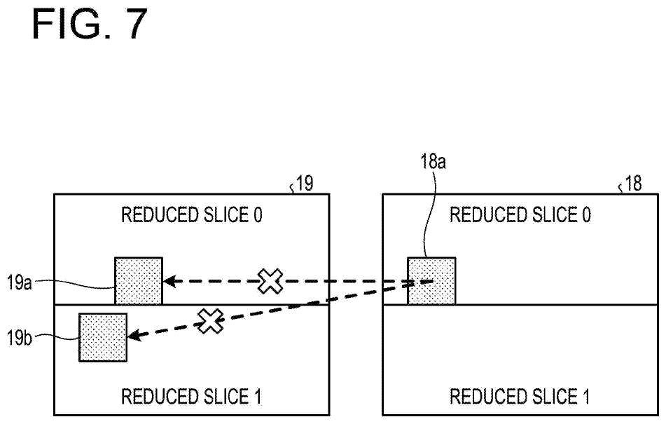

FIGS. 6 and 7 are views for explaining a processing for a block located at a lower end of a reduced slice. FIG. 6 illustrates an example where the block located at the lower end of the reduced slice is not a preferential object block. In FIG. 6, a picture 16 is a picture to be encoded, and a picture 17 is a reference picture of the picture 16. In the case where a block 16a is located at the lower end of the reduced slice 0, when the vertical component of a motion vector is less than 0, the block 16a is encoded with reference to blocks 17a and 17b, which indicates that no reference is made across the boundaries of reduced slices.

For example, assuming that the block 16a is the k-th block in the horizontal direction, the motion vector information of the block 16a is MV_Ver_L0[0][1][k] and MV_Ver_L1[0][1][k]. Since MV_Ver_L0[0][1][k] and MV_Ver_L1[0][1][k] are less than 0 (because the value of j is 1), assuming that the block 16a does not refer across the boundaries of the reduced slices, the determination unit 150 determines that the block 16a is not a preferential object block.

FIG. 7 illustrates an example where the block located at the lower end of the reduced slice is a preferential object block. In FIG. 7, a picture 18 is a picture to be encoded, and a picture 19 is a reference picture of the picture 18. In the case where a block 18a is located at the lower end of the reduced slice 0, when the vertical component of a motion vector is equal to or more than 0, the block 18a is encoded with reference to blocks 19a and 19b, which indicates that a reference is made across the boundaries of reduced slices.

For example, assuming that the block 18a is the k-th block in the horizontal direction, the motion vector information of the block 18a is MV_Ver_L0[0][0][k] and MV_Ver_L1[0][0][k]. Since MV_Ver_L0[0][0][k] and MV_Ver_L1[0][0][k] are equal to or more than 0 (because the value of j is 0), assuming that the block 18a refers across the boundaries of the reduced slices, the determination unit 150 determines that the block 18a is a preferential object block.

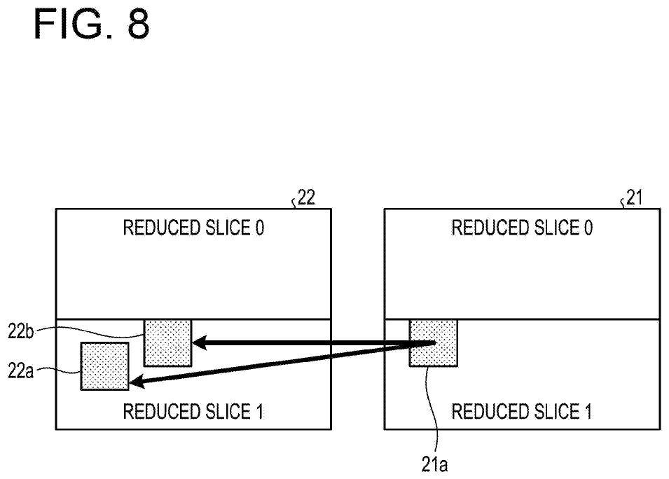

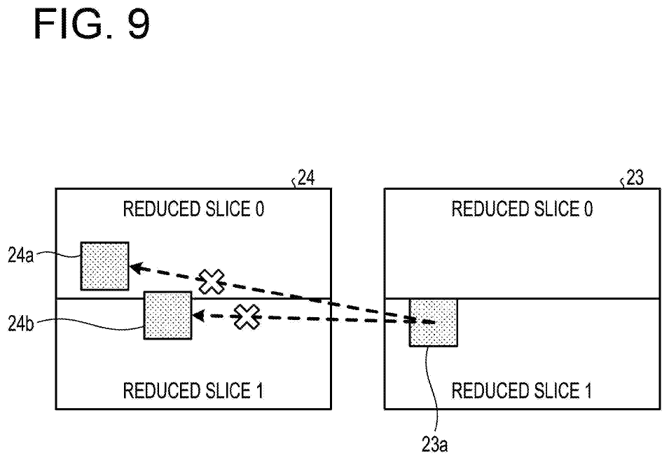

FIGS. 8 and 9 are views for explaining a processing for a block located at an upper end of a reduced slice. FIG. 8 illustrates an example where the block located at the upper end of the reduced slice is not a preferential object block. In FIG. 8, a picture 21 is a picture to be encoded, and a picture 22 is a reference picture of the picture 21. In the case where a block 21a is located at the upper end of the reduced slice 1, when the vertical component of a motion vector is equal to or more than 0, the block 21a is encoded with reference to blocks 22a and 22b, which indicates that no reference is made across the boundaries of reduced slices.

For example, assuming that the block 21a is the k-th block in the horizontal direction, the motion vector information of the block 21a is MV_Ver_L0[1][0][k] and MV_Ver_L1[1][0][k]. Since MV_Ver_L0[1][0][k] and MV_Ver_L1[1][0][k] are equal to or more than 0 (because the value of j is 0), assuming that the block 21a does not refer across the boundaries of the reduced slices, the determination unit 150 determines that the block 21a is not a preferential object block.

FIG. 9 illustrates an example where the block located at the upper end of the reduced slice is a preferential object block. In FIG. 9, a picture 23 is a picture to be encoded, and a picture 24 is a reference picture of the picture 23. In the case where a block 23a is located at the upper end of the reduced slice 1, when the vertical component of a motion vector is less than 0, the block 23a is encoded with reference to blocks 24a and 24b, which indicates that a reference is made across the boundaries of reduced slices.

For example, assuming that the block 23a is the k-th block in the horizontal direction, the motion vector information of the block 23a is MV_Ver_L0[1][1][k] and MV_Ver_L1[1][1][k]. Since MV_Ver_L0[1][1][k] and MV_Ver_L1[1][1][k] are less than 0 (because the value of j is 1), assuming that the block 23a refers across the boundaries of the reduced slices, the determination unit 150 determines that the block 23a is a preferential object block.

When the encoding mode of the block to be processed is an “inter prediction”, the determination unit 150 determines a preferential object block by repeatedly executing the above processing for each block included in each of the lines l0 to l3.

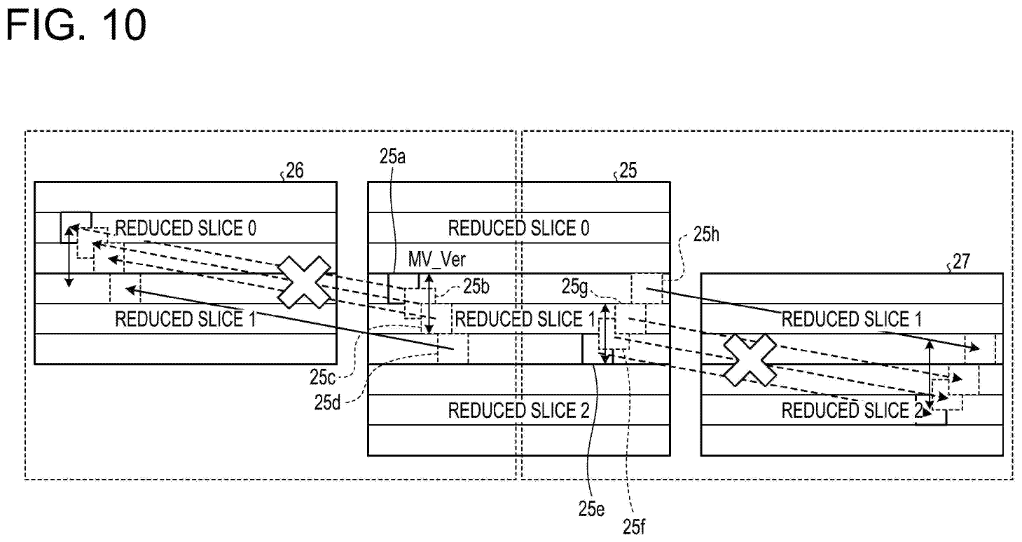

Subsequently, the determination unit 150 determines the range of image deterioration after determining the preferential object block included in each of the lines l0 to l5. FIG. 10 is a view for explaining a processing of determining the range of image deterioration. In FIG. 10, a picture 25 is a picture to be encoded, and pictures 26 and 27 are pictures to which the picture 25 refers.

When the motion vector information of a block 25a located at the upper end of the reduced slice 1 is less than 0, the image quality is deteriorated up to NU blocks away from the boundary of the upper end of the reduced slice. For this reason, the determination unit 150 determines that NU blocks away from the boundary of the upper end of the reduced slice are preferential object blocks. For example, it is assumed that NU blocks away from the boundary of the upper end of the reduced slice include blocks 25b and 25c and do not include a block 25d. In this case, the determination unit 130 determines that the blocks 25b and 25c are preferential object blocks. The determination unit 130 determines that the block 25d is not a preferential object block.

The determination unit 150 calculates the value of NU based on the following equation (1). In the equation (1), “MV_Ver” is a value of motion vector information of a preferential object block located at the upper end of the reduced slice. “CTBSize” is the size of a block and is preset. The decimal part is rounded up by the ceil function of the equation (1).

NU=ceil(−MV_Ver/CTBSize) (1)

In the meantime, when the motion vector information of the block 25e located at the lower end of the reduced slice 1 is equal to or more than 0, the image quality is deteriorated up to ND blocks away from the boundary of the lower end of the reduced slice. For this reason, the determination unit 150 determines that ND blocks away from the boundary of the lower end of the reduced slice are preferential object blocks. For example, it is assumed that ND blocks away from the boundary of the lower end of the reduced slice include blocks 25f and 25g and do not include a block 25h. In this case, the determination unit 130 determines that the blocks 25f and 25g are preferential object blocks. The determination unit 130 determines that the block 25h is not a preferential object block.

The determination unit 150 calculates the value of ND based on the following equation (2). In the equation (2), “MV_Ver” is a value of motion vector information of a preferential object block located at the lower end of the reduced slice. “CTBSize” is the size of a block and is preset. The decimal part is rounded up by the ceil function of the equation (2).

ND=ceil(MV_Ver/CTBSize) (2)

When the encoding mode of the block to be processed is an “inter prediction”, the determination unit 150 identifies the range of image deterioration based on the motion vector information of a block determined to be a preferential object block among the blocks included in each of the lines l0 to l3. The determination unit 150 determines that each block included in the range of image deterioration is a preferential object block.

Next, descriptions will be made on a processing of the determination unit 150 when the encoding mode of a block to be processed is the intra prediction.

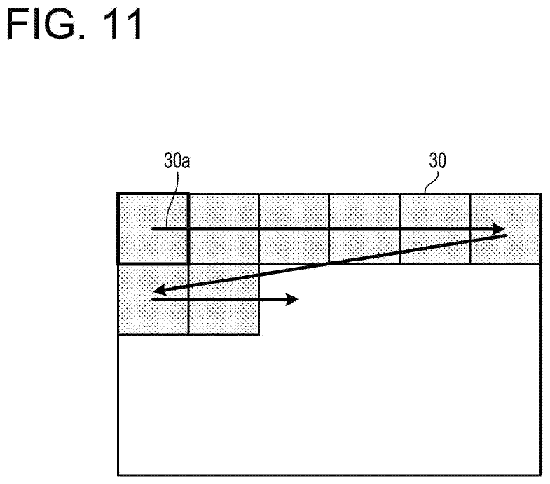

First, the intra prediction will be described. In encoding of image information (moving image), a single picture is divided into a plurality of blocks on which an encoding processing is performed. FIG. 11 is a view for explaining the order of encoding by intra prediction. As the encoding order in a picture 30, as indicated by an arrow 30a, an encoding processing on each block is performed in the order of Z scan from left to right and from top to bottom.

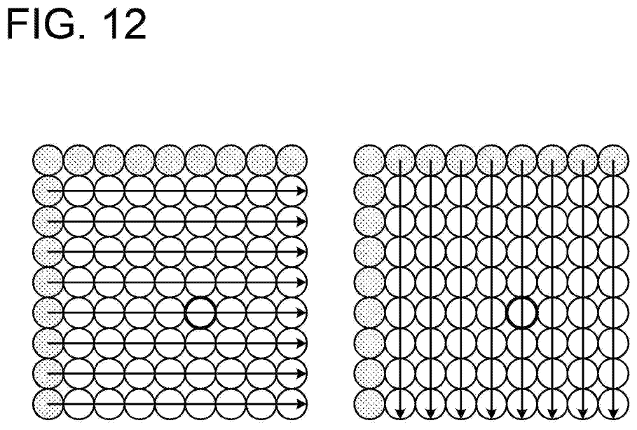

FIG. 12 is a view illustrating an example of generating a predicted image of a block to be encoded using two intra prediction modes. The prediction mode on the left of FIG. 12 indicates a horizontal prediction, and the prediction mode on the right indicates a vertical prediction. In the horizontal prediction, pixel values of an object block are predicted by copying pixel values of an adjacent single column of the left block of the object block in the horizontal direction. In the vertical prediction, pixel values of the object block are predicted by copying pixel values of an adjacent single row of the left block of the object block in the vertical direction.

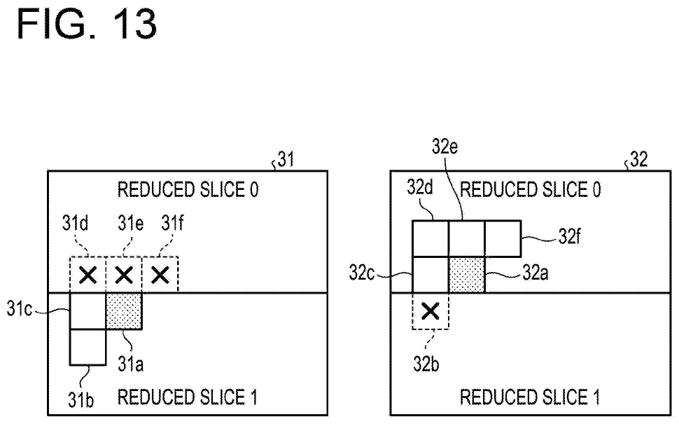

Subsequently, descriptions will be made on a processing of determining whether a block located at the upper end of the reduced slice is a preferential object block. FIG. 13 is a view for explaining a processing of the determination unit when the encoding mode is an intra prediction.

Description will be given with a picture 31 in FIG. 13. When encoding a block 31a located at the upper end of the reduced slice 1, blocks 31d, 31e, and 31f that may be originally referred to are located at the reduced slice 0, and the reference across the boundary of the reduced slice is made. For this reason, when the encoding mode for the block 31a is an intra prediction, the determination unit 130 determines that the block 31a is a preferential object block.

Description will be given with a picture 32 in FIG. 13. When encoding a block 32a located at the lower end of the reduced slice 2, the lower left block 32b is located at the reduced slice 1. Here, in the encoding order as described in FIG. 10, the block 32a is encoded without referring to the block 32b. For this reason, when the encoding mode for the block 32a is the intra prediction, the determination unit 130 determines that the block 32a is not a preferential object block.

When the encoding mode of the block to be processed is the “intra prediction”, the determination unit 150 determines a preferential object block by repeatedly executing the above processing for each block included in each of the lines l0 to l5.

Referring back to FIG. 2, the controller 160 is a processing unit that sets quantization parameters when the encoding units 170a to 170d perform a quantization on the blocks on the image information corresponding to the blocks on the reduced image information determined as the preferential object blocks by the determination unit 150, to be smaller than quantization parameters of non-preferential object blocks.

Here, since a block determined as a preferential object block by the determination unit 150 is a block of the reduced image information, the controller 160 identifies a block on the image information corresponding to the block determined as the preferential object block on the reduced image information and determines that the identified block is a preferential object block.

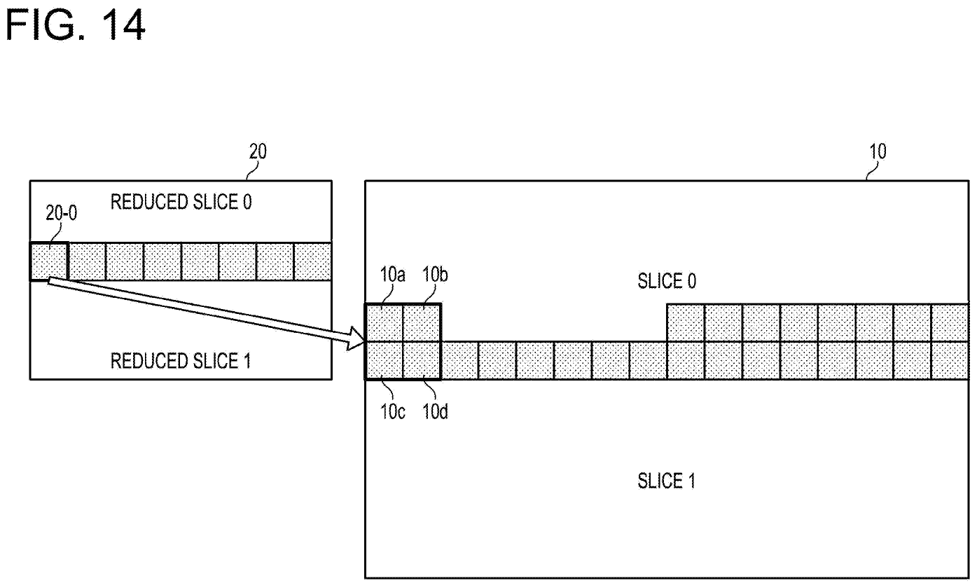

FIG. 14 is a view illustrating a correspondence between blocks on the reduced image information and blocks on the image information. The example illustrated in FIG. 14 represents image information 10 and reduced image information 20 that is obtained by reducing the image information 10. For example, when the reduction ratio is “½”, one block of the reduced image information 20 corresponds to four blocks of the image information 10. When the block 20-0 of the reduced slice 0 is a block determined as a preferential object block, the controller 160 determines that the blocks 10a, 10b, 10c, and 10d of the slice 0 are preferential object blocks.

The controller 160 calculates a quantization parameter QP′ of a preferential object block based on the following equation (3). In the equation (3), QP indicates a quantization parameter of a non-preferential object block. “QP_Offset” is a correction value for giving preference to the amount of information and is set with a value of 0 or more. For example, “QP_Offset=6” is set.

QP′=QP−QP_Offset (3)

By executing the above processing, the controller 160 outputs the positions of the preferential object blocks on the image information and the information of the quantization parameters for the preferential object blocks to the encoding units 170a to 170b.

More specifically, the controller 160 outputs the position of the preferential object block for the slice 0 on the image information and the information of the quantization parameter for the preferential object block to the encoding unit 170a. The controller 160 outputs the position of the preferential object block for the slice 1 on the image information and the information of the quantization parameter for the preferential object block to the encoding unit 170b. The controller 160 outputs the position of the preferential object block for the slice 2 on the image information and the information of the quantization parameter for the preferential object block to the encoding unit 170c. The controller 160 outputs the position of the preferential object block for the slice 3 on the image information and the information of the quantization parameter for the preferential object block to the encoding unit 170d.

The encoding units 170a to 170d are processing units that encode slices input from the dividing unit 120. The encoding units 170a to 170d encode preferential object blocks included in the slices using the quantization parameter QP′. The encoding units 170a to 170d encode non-preferential blocks included in the slices using the quantization parameter QP. When quantizing a block, the smaller the quantization parameter, the more information will be included in an encoded block. Since the quantization parameter QP′ is a value smaller than the quantization parameter QP, an encoded preferential object block contains more information than an encoded non-preferential object block.

The encoding unit 170a outputs the encoding result of the slice 0 to the transmitting unit 180. The encoding unit 170b outputs the encoding result of the slice 1 to the transmitting unit 180. The encoding unit 170c outputs the encoding result of the slice 2 to the transmitting unit 180. The encoding unit 170d outputs the encoding result of the slice 3 to the transmitting unit 180. The encoding units 170a to 170d repeatedly execute the above processing each time the slices 0 to 3 are received.

The transmitting unit 180 is a processing unit that receives the encoding results of the slices 0 to 3 from the encoding units 170a to 170d, and combines the respective encoding results to generate stream information. The transmitting unit 180 transmits the generated stream information to the decoding device 92.

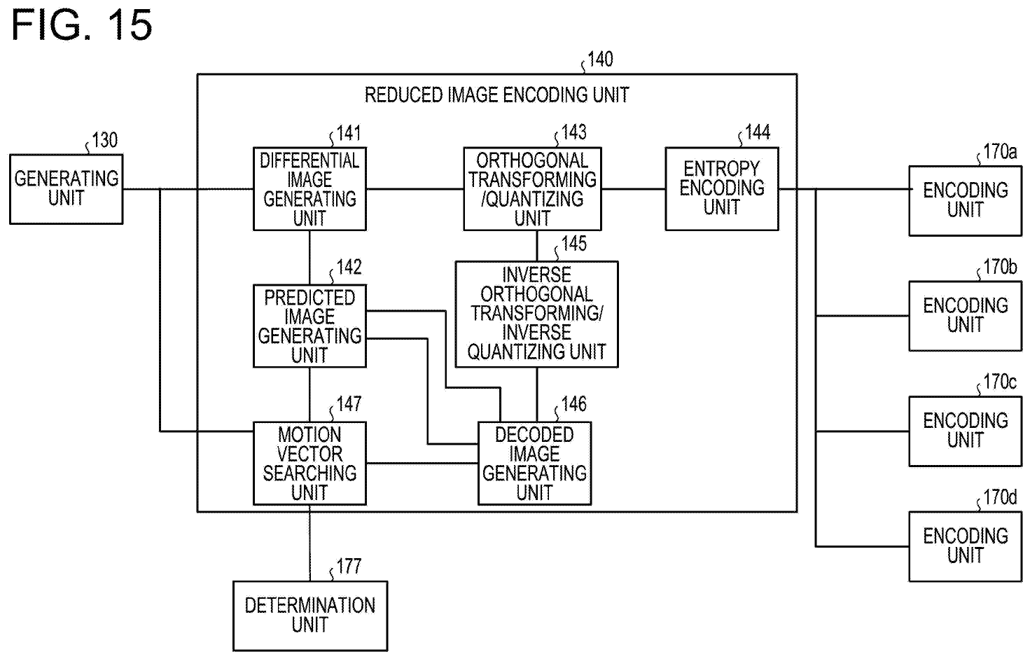

Next, an example of the configuration of the reduced image encoding unit 140 illustrated in FIG. 2 will be described. FIG. 15 is a functional block diagram illustrating the configuration of a reduced image encoding unit according to the first embodiment. As illustrated in FIG. 15, the reduced image encoding unit 140 includes a differential image generating unit 141, a predicted image generating unit 142, an orthogonal transforming/quantizing unit 143, and an entropy encoding unit 144. The reduced image encoding unit 140 further includes an inverse orthogonal transforming/inverse quantizing unit 145, a decoded image generating unit 146, and a motion vector searching unit 147.

Although the reduced image information encoded by the reduced image encoding unit 140 is divided into four reduced slices, it is assumed that the reduced image encoding unit 140 collectively encodes the reduced slices.

The differential image generating unit 141 is a processing unit that generates differential image information between the reduced image information input from the generating unit 130 and the predicted image information input from the predicted image generating unit 142. The differential image generating unit 141 outputs the differential image information to the orthogonal transforming/quantizing unit 143.

The predicted image generating unit 142 is a processing unit that generates the predicted image information by referring to the decoded image information acquired from the decoded image generating unit 146 based on the motion vector information acquired from the motion vector searching unit 147. The predicted image information includes a block to be encoded.

The orthogonal transforming/quantizing unit 143 orthogonally transforms the differential image information to obtain a frequency signal. The orthogonal transforming/quantizing unit 143 quantizes the frequency signal to generate a quantized signal. The orthogonal transforming/quantizing unit 143 outputs the quantized signal to the entropy encoding unit 144 and the inverse orthogonal transforming/inverse quantizing unit 145.

The entropy encoding unit 144 is a processing unit that performs an entropy encoding (variable length encoding) on the quantized signal. The entropy encoding unit 144 outputs the encoding result to the encoding units 170a to 170d. The entropy encoding is a method of allocating a code to a variable length according to the appearance frequency of a symbol. A shorter code is allocated to a symbol having a higher appearance frequency.

The inverse orthogonal transforming/inverse quantizing unit 145 extracts the frequency signal by performing an inverse quantization on the quantized signal. The inverse orthogonal transforming/inverse quantizing unit 145 generates image information (differential image information) by performing an inverse orthogonal transformation on the frequency signal. The inverse orthogonal transforming/inverse quantizing unit 145 outputs the differential image information to the decoded image generating unit 146.

The decoded image generating unit 146 is a processing unit that generates decoded image information by adding the predicted image information input from the predicted image generating unit 142 and the differential image information input from the inverse orthogonal transforming/inverse quantizing unit 145. The decoded image generating unit 146 outputs the generated decoded image information to the predicted image generating unit 142 and the motion vector searching unit 147.

The motion vector searching unit 147 is a processing unit that generates motion vector information based on the reduced image information input from the generating unit 130 and the decoded image information input from the decoded image information. The motion vector searching unit 147 outputs the generated motion vector information to the predicted image generating unit 142.

In addition, the motion vector searching unit 147 generates statistical information on the reduced slices 0 to 3 of the reduced image information and stores the statistical information in a storage area of the determination unit 150. A processing of the motion vector searching unit 147 that generates the statistical information corresponds to the processing described with reference to FIGS. 4 and 5.

The motion vector searching unit 147 divides the reduced slices 0 to 3 into a plurality of blocks (CTBs). When the blocks include inter prediction blocks, the motion vector searching unit 147 generates motion vector information 1A and 1B and store such information in a storage area of the determination unit 150. When the blocks include intra prediction blocks, the motion vector searching unit 147 generates motion vector information 1C and stores such information in a storage area of the determination unit 150.

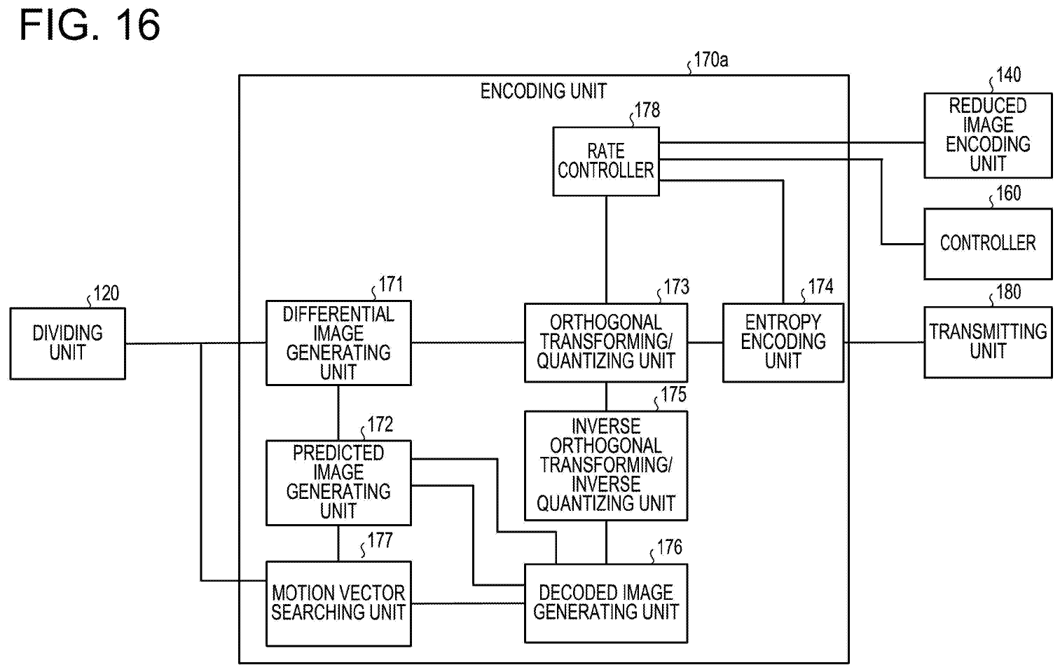

Next, an example of the configuration of the encoding unit 170a illustrated in FIG. 2 will be described. The encoding units 170b to 170d have the same configuration as the encoding unit 170a, and therefore, the explanation thereof will not be repeated. FIG. 16 is a functional block diagram illustrating the configuration of an encoding unit according to the first embodiment. As illustrated in FIG. 16, the encoding unit 170a includes a differential image generating unit 171, a predicted image generating unit 172, an orthogonal transforming/quantizing unit 173, and an entropy encoding unit 174. The encoding unit 170a further includes an inverse orthogonal transforming/inverse quantizing unit 175, a decoded image generating unit 176, a motion vector searching unit 177, and a rate controller 178.

The differential image generating unit 171 is a processing unit that generates differential image information between the slice 0 input from the dividing unit 120 and the predicted image information input from the predicted image generating unit 172. The differential image generating unit 171 outputs the differential image information to the orthogonal transforming/quantizing unit 173.

The differential image generating unit 171 of the encoding unit 170b receives the slice 1 from the dividing unit 120. The differential image generating unit 171 of the encoding unit 170c receives the slice 2 from the dividing unit 120. The differential image generating unit 171 of the encoding unit 170d receives the slice 3 from the dividing unit 120.

The predicted image generating unit 172 is a processing unit that generates predicted image information by referring to the decoded image information acquired from the decoded image generating unit 176 based on the motion vector information acquired from the motion vector searching unit 177. The predicted image information includes a block to be encoded.

The orthogonal transforming/quantizing unit 173 obtains a frequency signal by performing an orthogonal transformation on the differential image information. The orthogonal transforming/quantizing unit 173 quantizes the frequency signal to generate a quantized signal. The orthogonal transforming/quantizing unit 173 outputs the quantized signal to the entropy encoding unit 174 and the inverse orthogonal transforming/inverse quantizing unit 175.

Here, when the orthogonal transforming/quantizing unit 173 performs a quantization, a quantization parameter for each block is notified by the rate controller 178. The orthogonal transforming/quantizing unit 173 performs a quantization for each block according to the notified quantization parameter. Specifically, when quantizing a preferential object block, the orthogonal transforming/quantizing unit 173 performs a quantization with the quantization parameter QP′. When quantizing a non-preferential object block, the orthogonal transforming/quantizing unit 173 performs a quantization using the quantization parameter QP.

The entropy encoding unit 174 is a processing unit that performs an entropy encoding (variable length encoding) on the quantized signal. The entropy encoding unit 174 outputs the encoding result to the transmitting unit 180.

The inverse orthogonal transforming/inverse quantizing unit 175 extracts a frequency signal by performing an inverse quantization on the quantized signal. The inverse orthogonal transforming/inverse quantizing unit 175 generates image information (differential image information) by performing an inverse orthogonal transformation on the frequency signal. The inverse orthogonal transforming/inverse quantizing unit 175 outputs the differential image information to the decoded image generating unit 176.

The decoded image generating unit 176 is a processing unit that generates decoded image information by adding the predicted image information input from the predicted image generating unit 172 and the differential image information input from the inverse orthogonal transforming/inverse quantizing unit 175. The decoded image generating unit 176 outputs the generated decoded image information to the predicted image generating unit 172 and the motion vector searching unit 177.

The motion vector searching unit 177 is a processing unit that generates motion vector information based on the slice 0 input from the dividing unit 120 and the decoded image information input from the decoded image generating unit 176. The motion vector searching unit 177 outputs the generated motion vector information to the predicted image generating unit 172.

The motion vector searching unit 177 of the encoding unit 170b receives the slice 1 from the dividing unit 120. The motion vector searching unit 177 of the encoding unit 170c receives the slice 2 from the dividing unit 120. The motion vector searching unit 177 of the encoding unit 170d receives the slice 3 from the dividing unit 120.

The rate controller 178 is a processing unit that notifies the orthogonal transforming/quantizing unit 173 of the quantization parameter in the case of quantizing each block. The rate controller 178 acquires information on the position of the preferential object block and the quantization parameter of the preferential object block from the controller 160.

Further, the rate controller 178 acquires the encoding result of the reduced image information from the reduced image encoding unit 140, compares the data amounts allocated to the reduced slices 0 to 3, and identifies the complexity of the images of the reduced slices 0 to 3. For example, when the data amount of the reduced slice 0 is larger than the data amounts of the reduced slices 1 to 3, the slice 0 contains a complex image. In this case, the rate controller 178 increases the encoding rate of the entropy encoding unit 174 to be higher than a reference rate.

In the meantime, when the data amount of the reduced slice 0 is smaller than the data amounts of the reduced slices 1 to 3, the slice 0 does not contain a complex image. In this case, the rate controller 178 decreases the encoding rate of the entropy encoding unit 174 to be lower than the reference rate.

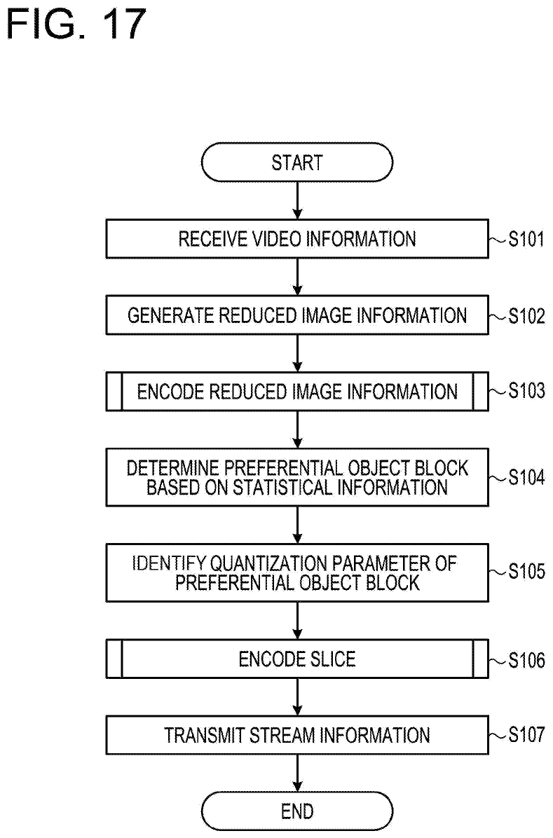

Next, an example of the processing procedure of the encoding device 100 according to the first embodiment will be described. FIG. 17 is a flowchart of the processing procedure of the encoding device according to the first embodiment. As illustrated in FIG. 17, the receiving unit 110 of the encoding device 100 receives video information from the camera 91 (step S101).

The generating unit 130 of the encoding device 100 generates reduced image information (step S102). The reduced image encoding unit 140 of the encoding device 100 executes a processing of encoding the reduced image information (step S103). The determination unit 150 of the encoding device 100 determines a preferential object block based on the statistical information (step S104).

The controller 160 of the encoding device 100 identifies the quantization parameter of the preferential object block (step S105). The encoding units 170a to 170d of the encoding device 100 execute a slice encoding processing (step S106). The transmitting unit 180 of the encoding device 100 transmits stream information to the decoding device 92 (step S107).

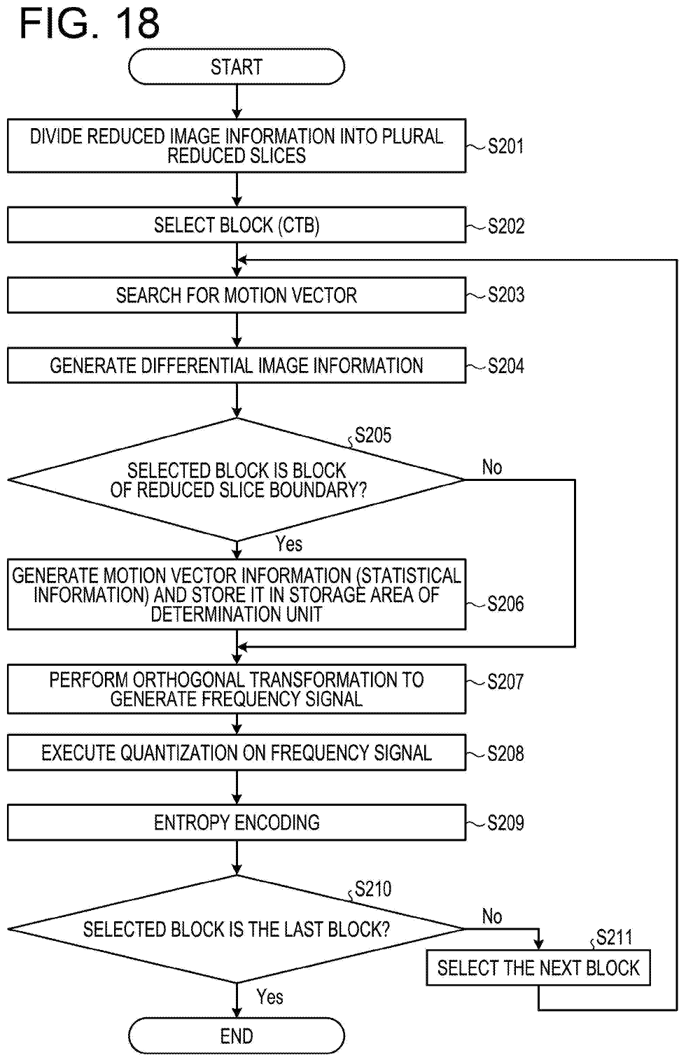

Next, the reduced image information encoding processing illustrated in step S103 in FIG. 17 will be described. FIG. 18 is a flowchart of the reduced image information encoding processing according to the first embodiment. As illustrated in FIG. 18, the reduced image encoding unit 140 divides the reduced image information into a plurality of reduced slices (step S201).

The reduced image encoding unit 140 selects a block (step S202). The motion vector searching unit 147 of the reduced image encoding unit 140 searches for a motion vector (step S203). The differential image generating unit 141 of the reduced image encoding unit 140 generates differential image information (step S204).

The motion vector searching unit 147 determines whether the selected block is a block at a reduced slice boundary (step S205). When it is determined that the selected block is a block at a reduced slice boundary (“Yes” in step S205), the motion vector searching unit 147 proceeds to step S206. In the meantime, when it is determined that the selected block is not a block at the reduced slice boundary (“No” in step S205), the motion vector searching unit 147 proceeds to step S207.

The motion vector searching unit 147 generates motion vector information (statistical information) and stores such information in a storage area of the determination unit 150 (step S206). The orthogonal transforming/quantizing unit 143 of the reduced image encoding unit 140 performs an orthogonal transforming processing on the differential image information to generate a frequency signal (step S207). The orthogonal transforming/quantizing unit 143 performs a quantizing processing on the frequency signal (step S208).

The entropy encoding unit 144 of the reduced image encoding unit 140 performs an entropy encoding (step S209). The reduced image encoding unit 140 determines whether the selected block is the last block (step S210). When it is determined that the selected block is the last block (“Yes” in step S210), the reduced image encoding unit 140 ends the processing.

In the meantime, when it is determined that the selected block is not the last block (“No” in step S210), the reduced image encoding unit 140 selects the next block (step S211) and proceeds to step S203.

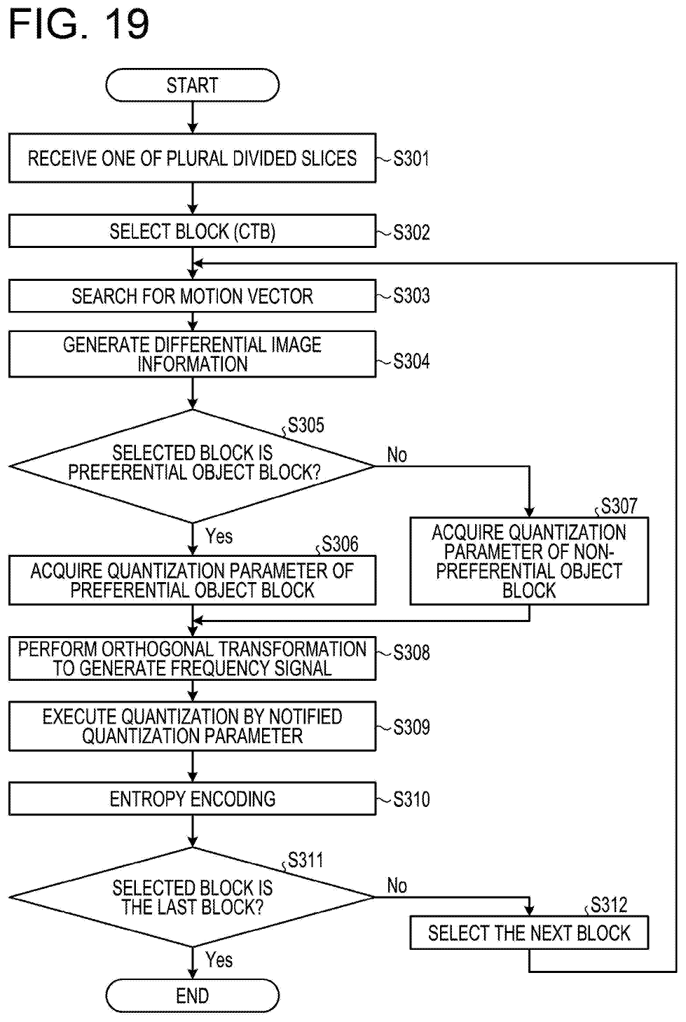

Next, the slice encoding processing illustrated in step S106 in FIG. 17 will be described. FIG. 19 is a flowchart of the slice encoding processing according to the first embodiment. Although FIG. 19 illustrates the processing procedure of the encoding unit 170a as an example, the processing procedures of the encoding units 170b to 170d are the same as the processing procedure of the encoding unit 170a except for a slice to be encoded.

As illustrated in FIG. 19, the encoding unit 170a receives one of the plurality of divided slices (step S301). The encoding unit 170a selects a block (step S302).

The motion vector searching unit 177 of the encoding unit 170a searches for a motion vector (step S303). The differential image generating unit 171 of the encoding unit 170a generates differential image information (step S304). When the selected block is a preferential object block (“Yes” in step S305), the rate controller 178 of the encoding unit 170a acquires the quantization parameter of the preferential object block (step S306).

In the meantime, when the selected block is not a preferential object block (“No” in step S305), the rate controller 178 acquires the quantization parameter of a non-preferential object block (step S307).

The orthogonal transforming/quantizing unit 173 of the encoding unit 170a performs an orthogonal transforming processing on the differential image information to generate a frequency signal (step S308). The orthogonal transforming/quantizing unit 173 executes a quantizing processing based on the notified quantization parameter (step S309).

The entropy encoding unit 174 of the encoding unit 170a performs an entropy encoding (step S310). The encoding unit 170a determines whether the selected block is the last block (step S311). When it is determined that the selected block is the last block (“Yes” in step S311), the encoding unit 170a ends the processing.

In the meantime, when it is determined that the selected block is not the last block (“No” in step S311), the encoding unit 170a selects the next block (step S312) and proceeds to step S303.

Next, the effects of the encoding device 100 according to the first embodiment will be described. The encoding device 100 identifies a block having a reduced quantization parameter among blocks included in a slice of the image information based on a plurality of reduced slices obtained by slicing the reduced image information. This may improve the boundary deterioration in a spatial parallel processing. In addition, since the encoding device 100 performs a control to reduce the quantization parameter for the identified block without performing a control to reduce the quantization parameters for all blocks located at the slice boundary, the amount of data to be allocated to the slice boundary may be saved, so that the deterioration of images may be suppressed as the whole picture.

Here, the processing of the controller 160 described in the first embodiment to calculate a quantization parameter is merely an example. The controller 160 may perform other processes to calculate a quantization parameter.

Another processing (1) of the controller 160 to calculate a quantization parameter will be described. When a preferential object block is “BiPred prediction”, the controller 160 may adjust the quantization parameter depending on whether a block referred to in both of two reference directions (forward and backward) is located in a slice different from the preferential object block.

For example, when a block referred to in both of two reference directions (bidirectional) is located in a slice different from the preferential object block, the controller 160 sets the offset used in the equation (3) as “QP_Offset=6”. In the meantime, when a block referred to in at least one of two reference directions is located in the same slice as the preferential object block, the controller 160 sets the offset used in the equation (3) as “QP_Offset=3”.

By switching the offset as described above, the controller 160 may make a quantization parameter in the case where reference may not be made in both directions smaller than a quantization parameter in the case where reference may not be made only in one direction. Since the image deterioration becomes greater in the case where reference may not be made in both directions than the case where reference may not be made only in one direction, the quantization parameter is further reduced.

Subsequently, another processing (2) of the controller 160 to calculate a quantization parameter will be described. When a block to be encoded is an intra prediction, the controller 160 may adjust the quantization parameter according to intra prediction direction.

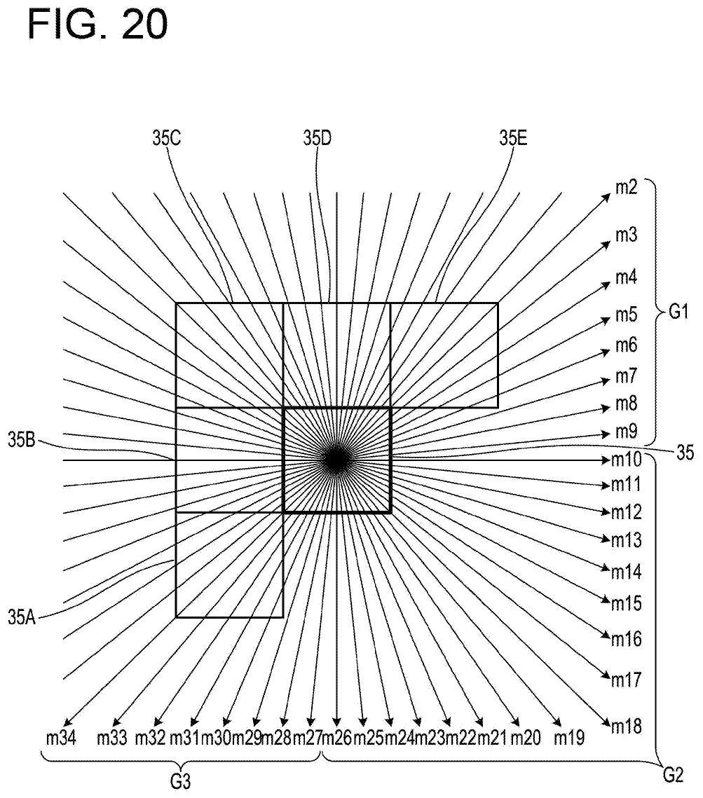

FIG. 20 is a view illustrating classification of intra prediction directions. For example, a block to be encoded is a block 35. A block on the lower left of the block 35 is a block 35A. A block on the left of the block 35 is a block 35B. A block on the upper left of the block 35 is a block 35C. A block above the block 35 is a block 35D. A block on the upper right of the block 35 is a block 35E.

The controller 160 classifies the prediction directions into groups G1 to G3 based on the positions of peripheral pixels that are used when generating a predicted image of the block 35. The group G1 includes prediction modes m2 to m9. The group G2 includes prediction modes m10 to m26. The group G3 includes prediction modes m27 to m34.

When the pixels of only the blocks 35A and 35B are used to generate the predicted image of the block 35, the controller 160 classifies the intra prediction direction of the block 35 as the group G1. When the block 35 is located at the upper end of the slice, the blocks 35A and 35B may be referred to because they are located in the same slice. Therefore, when the block 35 is classified as the group G1, the controller 160 calculates the quantization parameter QP′ with the offset of the equation (3) set as “QP_Offset=0”. Since “QP_Offset=0”, the quantization parameter QP′ has the same value as the quantization parameter QP of a non-preference object block.

When the pixels of only the blocks 35B, 35C, and 35D are used to generate the predicted image of the block 35, the controller 160 classifies the intra prediction direction of the block 35 as the group G2. When the block 35 is located at the upper end of the slice, a part of the blocks may not be referred to because the blocks 35C and 35D are located in different slices. Therefore, when the block 35 is classified as the group G2, the controller 160 calculates the quantization parameter QP′ with the offset of the equation (3) set as “QP_Offset=3”.

When the pixels of only the blocks 35D and 35E are used to generate the predicted image of the block 35, the controller 160 classifies the intra prediction direction of the block 35 as the group G3. When the block 35 is located at the upper end of the slice, all blocks may not be referred to because the blocks 35D and 35E are located in different slices. Therefore, when the block 35 is classified as the group G3, the controller 160 calculates the quantization parameter QP′ with the offset of the equation (3) set as “QP_Offset=6”.

As described above, when a block to be encoded is the intra prediction, the controller 160 may allocate an appropriate amount of data when quantizing the block by adjusting a quantization parameter according to the direction of intra prediction.

### Second Embodiment

Next, an encoding device according to a second embodiment will be described. The encoding device according to the second embodiment adjusts the quantization parameter of a block determined as a preferential object block based on a prediction error of the reduced image information and a prediction error of the image information. The encoding device may estimate that the deterioration of image quality is large when the deviation between the prediction errors becomes large, and makes the quantization parameter smaller based on the estimation.

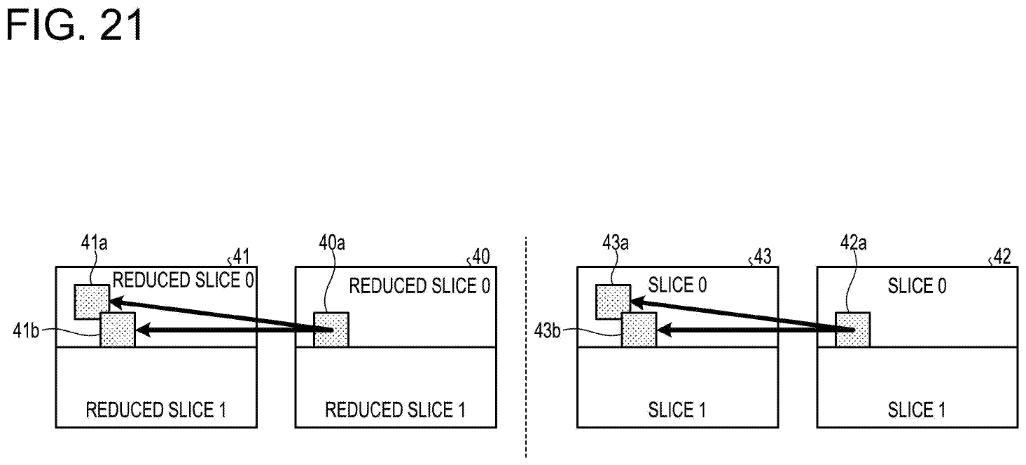

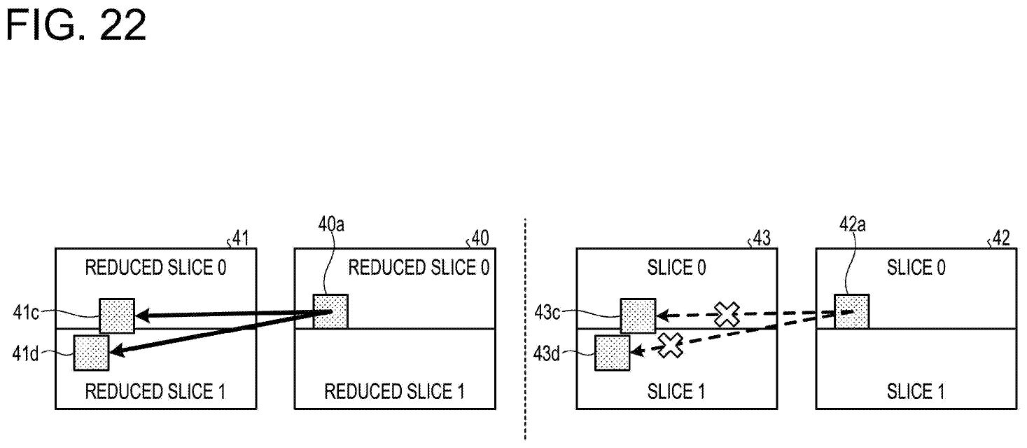

FIGS. 21 and 22 are views for explaining a processing of the encoding device according to the second embodiment. A case where the prediction error of the reduced image information and the prediction error of the image information become smaller will be described with reference to FIG. 21. In this case, since the deviation between the prediction errors is small, it is estimated that the deterioration of image is small.

In FIG. 21, a picture 40 is reduced image information to be encoded. A picture 41 is a reference picture of the picture 40. A block which is most similar to a block 40a of the reduced slice 0 of the picture 40 is a block 41a of the reduced slice 0 of the picture 41. Since the reduced slices 0 and 1 are processed by a single encoding unit (reduced image encoding unit to be described later), motion vector search (ME: Motion Estimation) hits to decrease the prediction errors. The block most similar to the block 40a is the same as in the case of a block 41b.

A picture 42 is image information to be encoded. A picture 43 is a reference picture of the picture 42. A block which is most similar to a block 42a of the slice 0 of the picture 42 is a block 43a of the slice 0 of the picture 43. Since the blocks 42a, 43a, and 43b are located at the slice 0 and are processed by a single encoding unit, motion vector search hits to decrease the prediction errors. The block most similar to the block 42a is the same as in the case of the block 43b.

As described with reference to FIG. 21, since the prediction error of the reduced image information is small and the prediction error of the image information is small, the deviation between the prediction errors is small. As a result, it is estimated that the deterioration of image is small.

FIG. 22 illustrates a case where the prediction error of the reduced image information is small and the prediction error of the image information is large. In this case, since the deviation between the prediction errors is large, it is estimated that the deterioration of image is large.

In FIG. 22, a picture 40 is reduced image information to be encoded. A picture 41 is a reference picture of the picture 40. Blocks which are most similar to a block 40a of the reduced slice 0 of the picture 40 are a block 41c of the reduced slice 0 of the picture 41 and a block 41d of the reduced slice 1 of the picture 41. Since the reduced slices 0 and 1 are processed by a single encoding unit (reduced image encoding unit to be described later), motion vector search hits to decrease the prediction errors.

A picture 42 is reduced image information to be encoded. A picture 43 is a reference picture of the picture 42. Blocks which are most similar to a block 42a of the reduced slice 0 of the picture 42 are a block 43c of the reduced slices 0 and 1 of the picture 43 and a block 43d of the reduced slice 1 of the picture 43. Since the block 42a is located at the slice 0 and a part of the block 43c and the block 43d are located at the slice 1, the encoding unit for encoding the slice 0 may not reference the part of the block 43c and the block 43d. Therefore, the motion vector search misses to increase the prediction errors.

As described with reference to FIG. 22, since the prediction error of the reduced image information is small and the prediction error of the image information is large, the deviation between the prediction errors is large. As a result, it is estimated that the deterioration of image is small. The encoding device performs a control to make the quantization parameter of the block 42a of FIG. 22 smaller than the quantization parameter of the block 42a of FIG. 21.

In the second embodiment, a prediction error of a block located at a slice boundary of image information is appropriately denoted as SAD (Sum of Absolute Difference) 1. A prediction error of a block located at the reduced slice boundary of the reduced image information is denoted as “SAD2”.

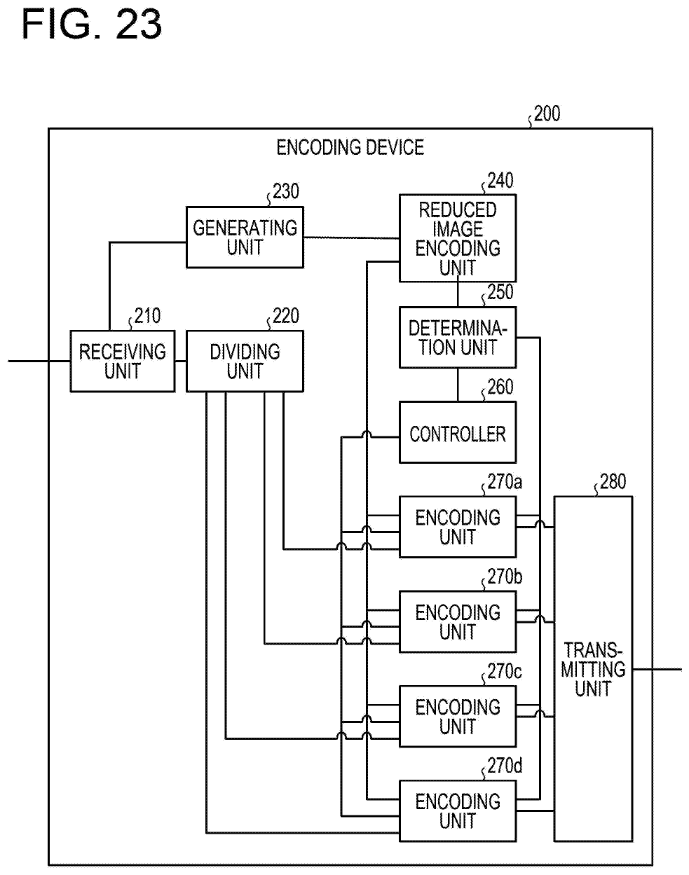

Next, the configuration of the encoding device according to the second embodiment will be described. FIG. 23 is a view illustrating the configuration of the encoding device according to the second embodiment. As illustrated in FIG. 23, the encoding device 200 includes a receiving unit 210, a dividing unit 220, a generating unit 230, a reduced image encoding unit 240, a determination unit 250, and a controller 260. The encoding device 200 further includes encoding units 270a, 270b, 270c, and 270d and a transmitting unit 280. The encoding device 200 is connected to a camera 91 and a decoding device 92 in the same manner as the encoding device 100.

The receiving unit 210 is a processing unit that receives video information from the camera 91. The receiving unit 210 outputs image information (picture) included in the video information to the dividing unit 220 and the generating unit 230.

The dividing unit 220 is a processing unit that divides the image information into a plurality of slices and outputs the slices to the encoding units 270a, 270b, 270c, and 270d. For example, the dividing unit 220 divides a picture 10 into four slices 0 to 3, as illustrated in FIG. 3. The dividing unit 220 outputs the slice 0 to the encoding unit 270a. The dividing unit 220 outputs the slice 1 to the encoding unit 270b. The dividing unit 220 outputs the slice 2 to the encoding unit 270c. The dividing unit 220 outputs the slice 3 to the encoding unit 270d. The dividing unit 220 repeatedly executes the above processing on the image information.

The generating unit 230 is a processing unit that generates reduced image information by reducing the image information to an image size that may be processed by a single encoder (e.g., the reduced image encoding unit 240). A processing in which the generating unit 230 generates the reduced image information is the same as the processing in which the generating unit 130 generates the reduced image information. The generating unit 230 outputs the reduced image information to the reduced image encoding unit 240.

The reduced image encoding unit 240 is a processing unit that divides the reduced image information into a plurality of reduced slices and encodes each of the reduced slices. For example, the reduced image encoding unit 240 divides the reduced image information 20 into four reduced slices 0 to 3 and encodes the reduced slices 0 to 3, as illustrated in FIG. 4.

When encoding the reduced slices 0 to 3, the reduced image encoding unit 240 generates statistical information and stores the statistical information in a storage area of the determination unit 250. A processing in which the reduced image encoding unit 240 generates the statistical information is the same as the processing in which the reduced image encoding unit 140 generates the statistical information described in the first embodiment.

In addition to the statistical information, the reduced image encoding unit 240 calculates “SAD2” and stores the calculated “SAD2” in a storage area of the determination unit 250.

“SAD2” indicates a prediction error of a block located in each of lines l0 to l5 of a reduced slice. For example, SAD2 is defined as “1D” below. The symbol “i” of SAD2 indicates the position of a line in which a block is contained. For example, when the line of the block is the line 10 illustrated in FIG. 5, “0” is set to i. “1 to 5” is set to i. The symbol “k” of SAD2 indicates the number of a block in the horizontal direction, with the top as the 0th. For example, when an object block is the block 0-0 of FIG. 5, “0” is set to k. When the object block is the block 0-1, “1” is set to k.

SAD2[i][k] (1D)

The configuration of the reduced image encoding unit 240 according to the second embodiment is a configuration corresponding to the reduced image encoding unit 140 described with reference to FIG. 15. Here, the reduced image encoding unit 240 differs from the reduced image encoding unit 140 in that the differential image generating unit 141 calculates SAD2.

For example, the differential image generating unit 141 of the reduced image encoding unit 240 calculates the sum of absolute values of differences between blocks of the reduced image information and blocks of the predicted image information as SAD2. The differential image generating unit 141 stores information of the calculated SAD2 in a storage area of the determination unit 250.

The determination unit 250 is a processing unit that determines a block to be treated as a preferential object, based on the statistical information stored in the storage area. A processing in which the determination unit 250 determines a block to be treated as a preferential object is the same as the processing in which the determination unit 150 determines a block to be treated as a preferential object described in the first embodiment. The determination unit 250 outputs the determination result and the information on SAD1 and SAD2 stored in the storage area to the controller 160.

The controller 260 is a processing unit that sets quantization parameters when the encoding units 270a to 270d perform a quantization on the blocks on the image information corresponding to the blocks on the reduced image information determined as the preferential object blocks by the determination unit 250, to be smaller than quantization parameters of non-preferential object blocks.

The controller 260 calculates a quantization parameter QP′ of a preferential object block based on the equation (3). Here, the controller 260 calculates “QP_Offset” used in the equation (3) based on the following equation (4). For example, although the value of “MaxVal” included in the equation (4) is set to 12, it may be changed as appropriate. The “SAD1” included in the equation (4) indicates a prediction error of a block located at the slice boundary of the image information, and is defined by 1E to be described later. The “SAD2” included in the equation (4) indicates a prediction error of a block located at the reduced slice boundary of the reduced image information, and is defined by 1D described above. Here, it is an example of a calculation formula when generating a reduced image at a reduction ratio of ½ (horizontal and vertical). When the reduction ratio changes, “2*2” in the calculation formula may be changed to “1/(reduction ratio*reduction ratio)”.

$$QP\_offset = Min ( Max Val , 6 * \frac{SAD 1}{SAD 2 * 2 * 2} ) \qquad ( 4 )$$

By using the equation (4), the quantization parameter QP′ becomes a smaller value as SAD2 becomes larger than SAD1.

By executing the above processing, the controller 260 outputs information on the position of a preferential object block on the image information and the quantization parameter for the preferential object block to the encoding units 270a to 270d. A processing in which the controller 260 identifies the position of the preferential object block on the image information is the same as the processing of the controller 160 described with reference to FIG. 14.

The encoding units 270a to 270d are processing units that encode a slice input from the dividing unit 220. The encoding units 270a to 270d encode blocks included in the slice using the quantization parameter QP′. The encoding units 270a to 270d encode non-preferential blocks included in the slice using the quantization parameter QP.

The encoding unit 270a outputs the encoding result of the slice 0 to the transmitting unit 280. The encoding unit 270b outputs the encoding result of the slice 1 to the transmitting unit 280. The encoding unit 270c outputs the encoding result of the slice 2 to the transmitting unit 280. The encoding unit 270d outputs the encoding result of the slice 3 to the transmitting unit 280.

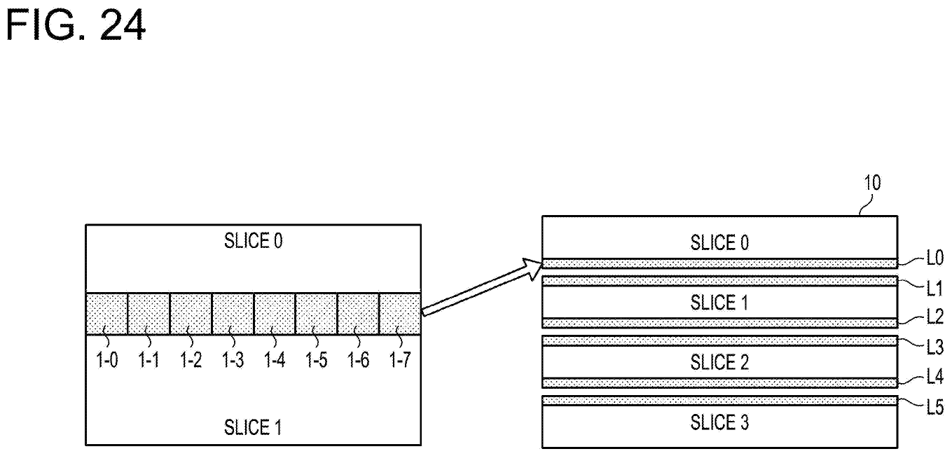

In addition, the encoding units 270a to 270d calculate “SAD1” and store the calculated “SAD1” in a storage area of the determination unit 250. FIG. 24 is a view defining each line of each slice. There is a line L0 in the slice 0 which is encoded by the encoding unit 270a. There are lines L1 and L2 in the slice 1 which is encoded by the encoding unit 270b. There are lines L3 and L4 in the slice 2 which is encoded by the encoding unit 270c. There is a line L5 in the slice 3 which is encoded by the encoding unit 270d.

SAD1 calculated by the encoding units 270a to 270d indicates a prediction error of a block located on the slice boundary line. For example, SAD1 is defined as “1E” below. The symbol “i” of SAD1 indicates the position of a line in which a block is contained. For example, when the line of the block is the line L0, “0” is set to i. One of the numbers “1 to 5” is set to i. The symbol “k” of SAD1 indicates the number of a block in the horizontal direction, with the top as the 0th. For example, when an object block is the block 1-0 of FIG. 24, “0” is set to k. When the object block is the block 0-1, “1” is set to k.

SAD1[i][k] (1E)

The encoding unit 270a calculates SAD1 of the line L0 and stores the calculated SAD1 in a storage area of the determination unit 250. The encoding unit 270b calculates SAD1 of the lines L1 and L2 and stores the calculated SAD1 in a storage area of the determination unit 250. The encoding unit 270c calculates SAD1 of the lines L3 and L4 and stores the calculated SAD1 in a storage area of the determination unit 250. The encoding unit 270d calculates SAD1 of the line L5 and stores the calculated SAD1 in a storage area of the determination unit 250.

The configuration of the encoding unit 270a according to the second embodiment is a configuration corresponding to the encoding unit 170a described with reference to FIG. 16. Here, the encoding unit 270a differs from the encoding unit 170a in that the differential image generating unit 171 calculates SAD1.

For example, the differential image generating unit 171 of the encoding unit 270a calculates the sum of absolute values of differences between blocks of the slice 0 and blocks of the predicted image information as SAD1. The differential image generating unit 171 stores information of the calculated SAD1 in a storage area of the determination unit 250.

Similarly, the differential image generating units 171 of the encoding units 270b to 270d calculate the sum of absolute values of differences between blocks of the slices 1 to 3 and blocks of the predicted image information as SAD1 and store information of the calculated SAD1 in a storage area of the determination unit 250.

The transmitting unit 280 is a processing unit that receives the encoding results of the slices 0 to 3 from the encoding units 270a to 270d and combines the respective encoding results to generate stream information. The transmitting unit 280 transmits the generated stream information to the decoding device 92.

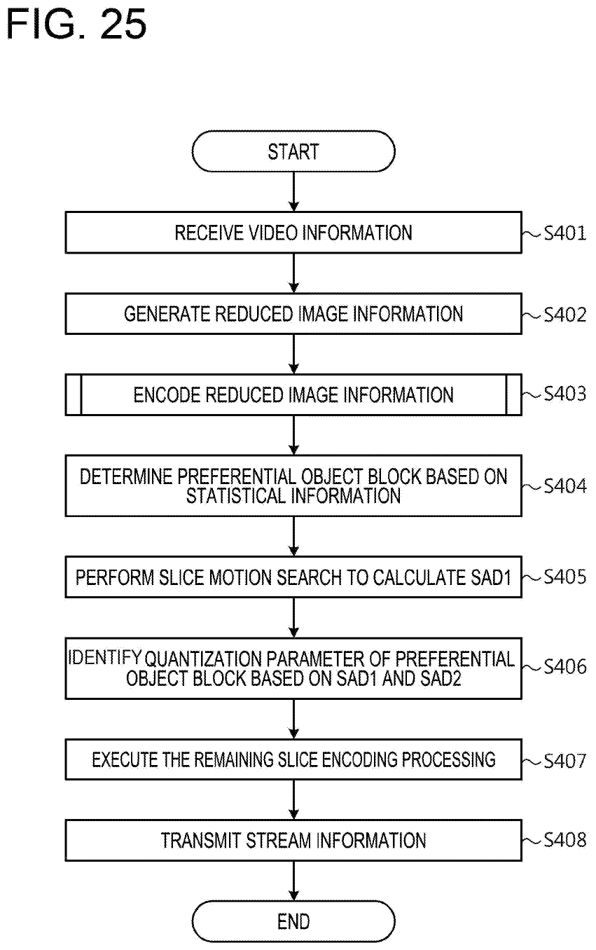

Next, an example of the processing procedure of the encoding device 200 according to the second embodiment will be described. FIG. 25 is a flowchart illustrating the processing procedure of the encoding device according to the second embodiment. As illustrated in FIG. 25, the receiving unit 210 of the encoding device 200 receives video information from the camera 91 (step S401).

The generating unit 230 of the encoding device 200 generates reduced image information (step S402). The reduced image encoding unit 240 of the encoding device 200 executes a processing of encoding the reduced image information (step S403). In step S403, when executing the reduced image encoding processing, the reduced image encoding unit 240 generates motion vector information and stores the generated motion vector information in a storage area of the determination unit 250. In addition, the reduced image encoding unit 240 calculates SAD2 and stores the calculated SAD2 in the determination unit 250.

The determination unit 250 of the encoding device 200 determines a preferential object block based on the statistical information (step S404). The encoding device 200 performs a slice motion search and calculates SAD1 (step S405). The controller 260 of the encoding device 200 identifies the quantization parameter of the preferential object block based on SAD1 and SAD2 (step S406).

The encoding units 270a to 270d of the encoding device 200 execute the remaining slice encoding processing (step S407). The transmitting unit 280 of the encoding device 200 transmits the stream information to the decoding device 92 (step S408).

Next, the effects of the encoding device 200 according to the second embodiment will be described. The encoding device 200 adjusts the quantization parameter of a block determined as a preferential object block based on the prediction error SAD2 of the reduced image information and the prediction error SAD1 of the image information. The encoding device may estimate that the deterioration of the image quality is large when a deviation between the prediction errors is large, and makes the quantization parameter smaller. As a result, the quantization parameter is optimized, and the necessary and sufficient image quality improvement may be implemented at the slice boundary. In addition, since the preferential treatment of the information amount at the slice boundary is limited to the minimum necessary, it is possible to reduce the loss of information in an area other than the slice boundary and to suppress the occurrence of unnecessary image quality deterioration.

### Third Embodiment

Next, an encoding device according to a third embodiment will be described. An encoding device according to the third embodiment generates statistical information (motion vector information) in line units of reduced slices, and determines whether to give a preferential treatment to each line. The encoding device performs a control to make the quantization parameter of each block included in a preferential object line smaller.

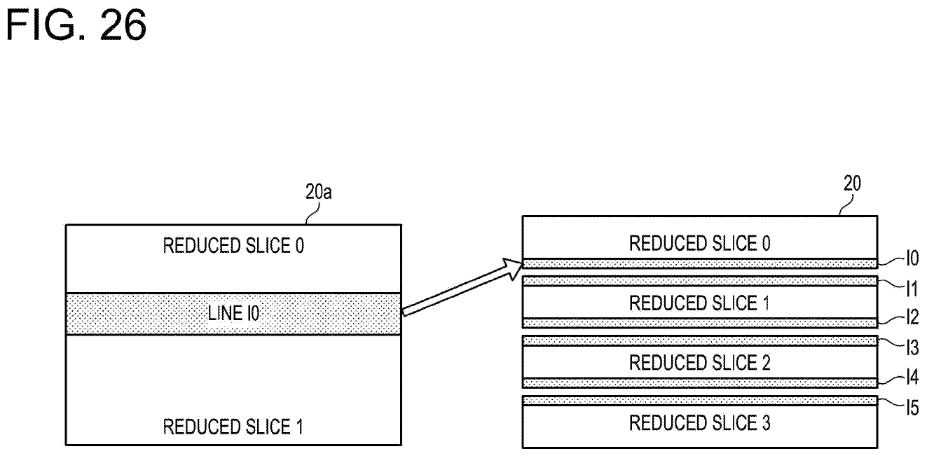

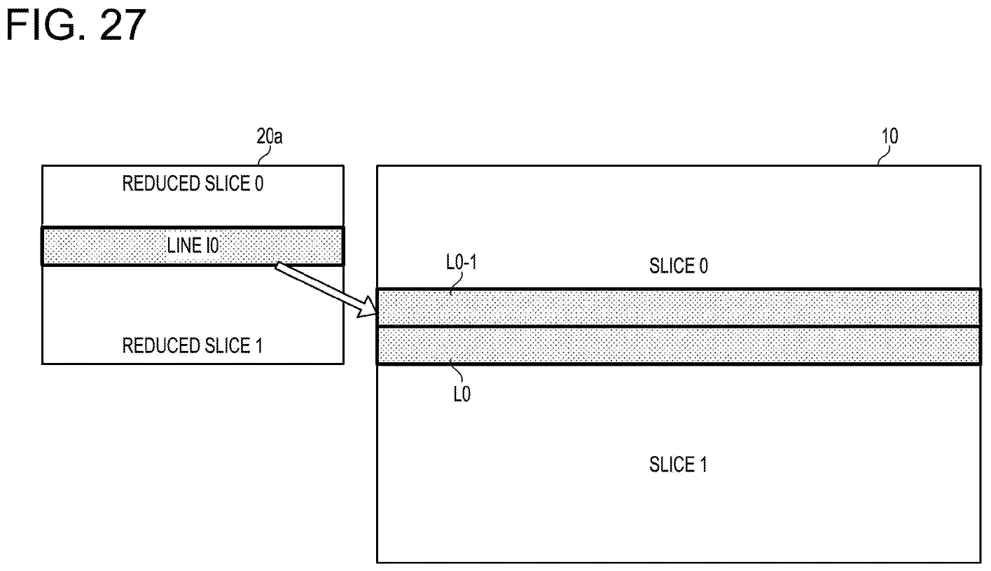

FIGS. 26 and 27 are views for explaining a processing of the encoding device according to the third embodiment. As illustrated in FIG. 26, the encoding device divides reduced image information 20 into a plurality of reduced slices 0 to 3 and generates statistical information for each line located at the boundary of each reduced slice.

The encoding device calculates motion vector information for each block included in a line l0. The encoding device records the average value of the motion vector information of each block as the motion vector information of the line l0. In addition, the encoding device calculates an accumulated value of SAD2 for each block included in the line l0.

Similarly, the encoding device calculates motion vector information for each block included in lines l1 to l5 and records the average value of the motion vector information of each block as the motion vector information of the lines l1 to l5. In addition, the encoding device calculates an accumulated value of SAD2 for each block included in the lines l1 to l5.

For the line l1 at the upper end of the reduced slice, when the average value of the motion vector is less than 0, the encoding device determines that each block of the line l1 is a preferential object block. For the line l3 at the upper end of the reduced slice, when the average value of the motion vector is less than 0, the encoding device determines that each block of the line l3 is a preferential object block. For the line l5 at the upper end of the reduced slice, when the average value of the motion vector is less than 0, the encoding device determines that each block of the line l5 is a preferential object block.

For the line l0 at the lower end of the reduced slice, when the average value of the motion vector is equal to or more than 0, the encoding device determines that each block of the line l0 is a preferential object block. For the line l2 at the lower end of the reduced slice, when the average value of the motion vector is equal to or more than 0, the encoding device determines that each block of the line l2 is a preferential object block. For the line l4 at the lower end of the reduced slice, when the average value of the motion vector is equal to or more than 0, the encoding device determines that each block of the line l4 is a preferential object block.

When determining a preferential object line (each block included in the line), the encoding device determines a line on the image information corresponding to the determined line on the reduced image information (a preferential object line). In FIG. 27, the line l0 of the reduced image information 20a is a preferential object line. Assuming that the reduction ratio is ½, the lines on the image information corresponding to the line l0 are lines L0 and L0-1. The vertical width of the lines L0 and L0-1 corresponds to the vertical width of a single block (CTB). Further, the encoding device calculates an accumulated value of SAD1 included in the lines L0 and L0-1.

The encoding device encodes each block included in the preferential object line on the image information with a quantization parameter that is smaller than a quantization parameter for a non-preferential object block. The encoding unit adjusts the quantization parameter based on the accumulated value of SAD1 and the accumulated value of SAD2.

As described above, since the encoding device according to the third embodiment determines whether to give a preferential treatment to each line, the preferential object blocks may be collectively determined on a line basis.

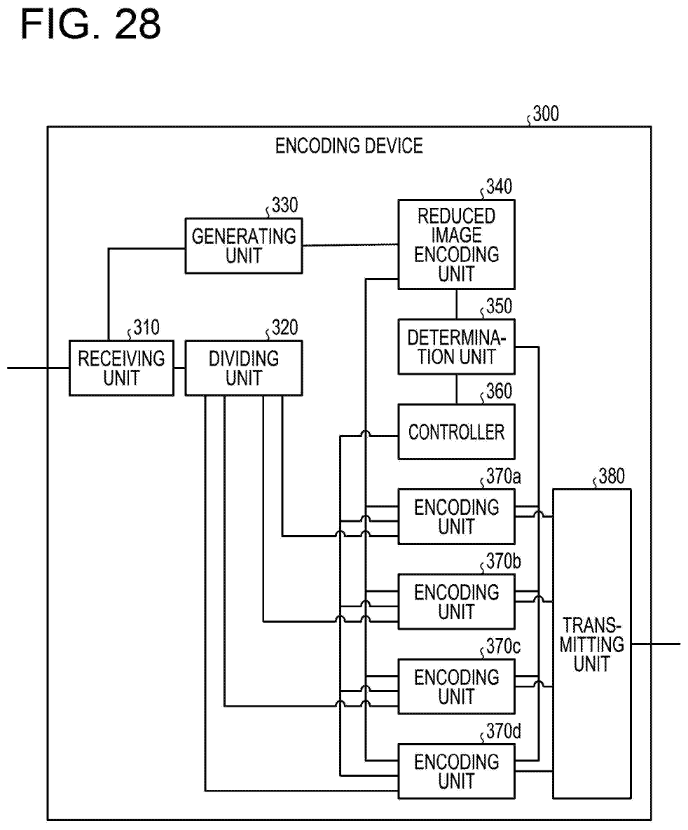

Next, the configuration of the encoding device according to the third embodiment will be described. FIG. 28 is a view illustrating the configuration of the encoding device according to the third embodiment. As illustrated in FIG. 28, the encoding device 300 includes a receiving unit 310, a dividing unit 320, a generating unit 330, a reduced image encoding unit 340, a determination unit 350, and a controller 360. The encoding device 300 further includes encoding units 370a, 370b, 370c, and 370d and a transmitting unit 380. The encoding device 300 is connected to a camera 91 and a decoding device 92 in the same manner as the encoding device 100.

The receiving unit 310 is a processing unit that receives video information from the camera 91. The receiving unit 310 outputs image information (picture) included in the video information to the dividing unit 320 and the generating unit 330.

The dividing unit 320 is a processing unit that divides the image information into a plurality of slices and outputs the slices to the encoding units 370a, 370b, 370c, and 370d. For example, the dividing unit 320 divides a picture (image information) 10 into four slices 0 to 3, as illustrated in FIG. 3. The dividing unit 320 outputs the slice 0 to the encoding unit 370a. The dividing unit 220 outputs the slice 1 to the encoding unit 370b. The dividing unit 320 outputs the slice 2 to the encoding unit 370c. The dividing unit 320 outputs the slice 3 to the encoding unit 370d. The dividing unit 320 repeatedly executes the above processing on the image information.

The generating unit 330 is a processing unit that generates reduced image information by reducing the image information to an image size that may be processed by a single encoder (e.g., the reduced image encoding unit 340). A processing in which the generating unit 330 generates the reduced image information is the same as the processing in which the generating unit 130 generates the reduced image information. The generating unit 330 outputs the reduced image information to the reduced image encoding unit 340.

The reduced image encoding unit 340 is a processing unit that divides the reduced image information into a plurality of reduced slices and encodes each of the reduced slices. For example, the reduced image encoding unit 340 divides the reduced image information 20 into four reduced slices 0 to 3 and encodes the reduced slices 0 to 3, as illustrated in FIG. 4.

When encoding the reduced slices 0 to 3, the reduced image encoding unit 340 generates statistical information for each line and stores the statistical information in a storage area of the determination unit 350. First, the reduced image encoding unit 340 calculates motion vector information 1A and motion vector information 1B for each block included in the line in the same manner as the reduced image encoding unit 140 described in the first embodiment. The reduced image encoding unit 340 calculates the average value of each block included in the line as statistical information corresponding to the line.

For example, the reduced image encoding unit 340 calculates statistical information of a line based on the following equations (5) and (6). The equation (5) is an average value of the vertical components of the motion vector of each block when the prediction direction is a forward direction. The equation (6) is an average value of the vertical components of the motion vector of each block when the prediction direction is a backward direction. In the equations (5) and (6), the symbol “i” indicates the position of a line in which a block is included. For example, when the line of the block is the line 10 illustrated in FIG. 5, “0” is set to i. The symbol “CTBNum” indicates the number of blocks included in the line. “ΣMV_Ver_L0(L1)_CTB[i][j][CTBNum]” indicates the sum of vertical components of motion vectors of each block included in the line.

MV_Ver_L0[i]=ΣMV_Ver_L0_CTB[i][CTBNum]/CTBNum (5)

MV_Ver_L1[i]=ΣMV_Ver_L1_CTB[i][CTBNum]/CTBNum (6)

In addition, the reduced image encoding unit 340 calculates the sum “SAD_Sum2” of SAD2 included in each line based on the following equation (7). The reduced image encoding unit 340 stores “SAD_Sum2” in a storage area of the determination unit 350.

SAD_Sum2[i]=ΣSAD2[i][CTBNum] (7)

The determination unit 350 is a processing unit that determines a preferential object line based on the statistical information stored in the storage area. The determination unit 350 determines whether the image quality deterioration occurs in the line according to the direction of the motion vector information of the line included in the statistical information.

For the line l1 at the upper end of the reduced slice, when the average value of the motion vector is less than 0, the determination unit 350 determines that each block of the line l1 is a preferential object block. For the line l3 at the upper end of the reduced slice, when the average value of the motion vector is less than 0, the determination unit 350 determines that each block of the line l3 is a preferential object block. For the line l5 at the upper end of the reduced slice, when the average value of the motion vector is less than 0, the determination unit 350 determines that each block of the line l5 is a preferential object block.

For the line l0 at the lower end of the reduced slice, when the average value of the motion vector is equal to or more than 0, the determination unit 350 determines that each block of the line l0 is a preferential object block. For the line l2 at the lower end of the reduced slice, when the average value of the motion vector is equal to or more than 0, the determination unit 350 determines that each block of the line l2 is a preferential object block. For the line l4 at the lower end of the reduced slice, when the average value of the motion vector is equal to or more than 0, the determination unit 350 determines that each block of the line l4 is a preferential object block.

The determination unit 350 outputs information of the line determined as the preferential object line to the controller 360. In addition, the determination unit 350 outputs the sum “SAD_Sum1” of SAD1 and the sum “SAD_Sum2” of SAD2 stored in the storage area to the controller 360. The sum “SAD_Sum1” of SAD1 is calculated by the encoding units 370a to 370d to be described later.

The controller 360 is a processing unit that sets quantization parameters when the encoding units 370a to 370d perform a quantization on the blocks on the image information corresponding to the blocks on the reduced image information determined as the preferential object blocks by the determination unit 350, to be smaller than quantization parameters of non-preferential object blocks.

The controller 360 calculates a quantization parameter QP′ of each block of the preferential object line based on the equation (3). Here, the controller 360 calculates “QP_Offset” used in the equation (3) based on the following equation (8). Here, it is an example of a calculation formula when generating a reduced image at a reduction ratio of ½ (horizontal and vertical). When the reduction ratio changes, “2*2” in the calculation formula may be changed to “1/(reduction ratio*reduction ratio)”.

$$QP\_offset = Min ( Max Val , 6 * \frac{SAD\_Sum 1}{SAD\_Sum 2 * 2 * 2} ) \qquad ( 8 )$$

In the equation (8), “SAD_Sum1” is the sum of SAD1 of each block included in the preferential object line on the image information. “SAD_Sum2” is the sum of SAD2 of each block included in the preferential object line on the reduced image information. The value of “MaxVal” is set as 12.

By executing the above processing, the controller 360 outputs information on the position of the preferential object line on the image information and the quantization parameter for the preferential object line (each block of the line) to the encoding units 370a to 370d. A processing in which the controller 360 identifies the position of the preferential object line on the image information is the same as the processing described with reference to FIG. 27, and so on.

The encoding units 370a to 370d are processing units that encode a slice input from the dividing unit 320. The encoding units 370a to 370d encode blocks included in the preferential object line included in the slice using the quantization parameter QP′. The encoding units 370a to 370d encode non-preferential blocks included in the slice using the quantization parameter QP.

The encoding unit 370a outputs the encoding result of the slice 0 to the transmitting unit 380. The encoding unit 370b outputs the encoding result of the slice 1 to the transmitting unit 380. The encoding unit 370c outputs the encoding result of the slice 2 to the transmitting unit 380. The encoding unit 370d outputs the encoding result of the slice 3 to the transmitting unit 380.

In addition, the encoding units 370a to 370d calculate each block “SAD1” included in the line in the same manner as the encoding units 270a to 270d. The encoding units 370a to 370d calculate the sum “SAD_Sum1” of SAD1 of the block for each line based on the following equation (9). The encoding units 370a to 370d store “SAD_Sum1” for each line in a storage area of the determination unit 350. In the equation (9), the symbol “i” indicates the position of a line in which a block is included.

SAD_Sum1[i]=ΣSAD1[i][CTBNum] (9)

The transmitting unit 380 is a processing unit that receives the encoding results of the slices 0 to 3 from the encoding units 370a to 370d and combines the respective encoding results to generate stream information. The transmitting unit 380 transmits the generated stream information to the decoding device 92.

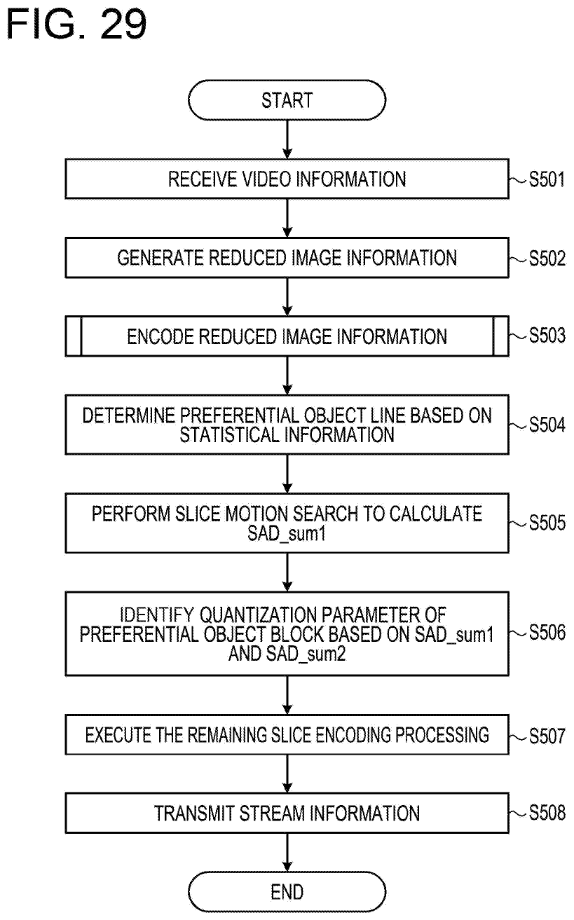

Next, an example of the processing procedure of the encoding device 300 according to the third embodiment will be described. FIG. 29 is a flowchart illustrating the processing procedure of the encoding device according to the third embodiment. As illustrated in FIG. 29, the receiving unit 310 of the encoding device 300 receives video information from the camera 91 (step S501).

The generating unit 330 of the encoding device 300 generates reduced image information (step S502). The reduced image encoding unit 340 of the encoding device 300 executes a processing of encoding the reduced image information (step S503). In step S503, when executing the reduced image encoding processing, the reduced image encoding unit 340 generates motion vector information of each line and stores the generated motion vector information in a storage area of the determination unit 350. In addition, the reduced image encoding unit 340 calculates SAD_Sum2 and stores the calculated SAD_Sum2 in a storage area of the determination unit 350.

The determination unit 350 of the encoding device 300 determines a preferential object line based on the statistical information (step S504). The encoding device 300 performs a slice motion search and calculates SAD_Sum1 (step S505). The controller 360 of the encoding device 300 identifies the quantization parameter of each block included in the preferential object line based on SAD_Sum1 and SAD_Sum2 (step S506).

The encoding units 370a to 370d of the encoding device 300 execute the remaining slice encoding processing (step S507). The transmitting unit 380 of the encoding device 300 transmits the stream information to the decoding device 92 (step S508).

Next, the effects of the encoding device 300 according to the third embodiment will be described. The encoding device 300 generates statistical information (motion vector information) in line units of reduced slices and determines whether to give a preferential treatment to each line. The encoding device 300 performs a control to make the quantization parameter of each block included in a preferential object line smaller. In this manner, since the encoding device 300 determines whether to give a preferential treatment to each line, the preferential object blocks may be collectively identified in line units, and the boundary image deterioration may be improved while reducing the processing amount.

Here, the processing in which the reduced image encoding unit 340 described in the third embodiment calculates statistical information (motion vector information) of a line is merely an example. The reduced image encoding unit 340 may perform other processes to calculate statistical information of the line.

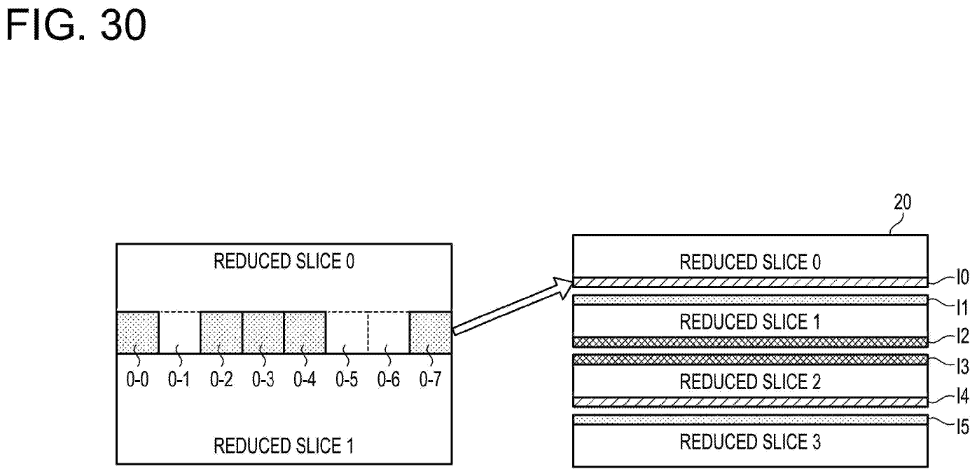

FIG. 30 is a view for explaining another processing of the reduced image encoding unit. For example, when calculating motion vector information of a line, the reduced image encoding unit 340 calculates statistical information of a line using a block referring across the reduced slice boundary among blocks included in the line. For example, blocks included in lines l0, l2 and l4 located at the lower end are blocks that refer across the reduced slice boundary when the vertical component of the motion vector information is equal to or more 0. In the meantime, blocks included in lines l1, l3, and l5 located at the upper end are blocks that refer across the reduced slice boundary when the vertical component of the motion vector information is less than 0.

In FIG. 30, blocks 0-0 to 0-7 are included in the line 10, and the blocks 0-0, 0-2 to 0-4, and 0-7 refer across the reduced slice boundary. In this case, the reduced image encoding unit 340 calculates the average value of the motion vector information of the blocks 0-0, 0-2 to 0-4, and 0-7 as the motion vector information of the line 10.

For example, the reduced image encoding unit 340 calculates motion vector information of a line based on the following equations (10) and (11). The equation (10) is an average value of the vertical components of the motion vector of each block (a block referring across the reduced slice boundary) when the prediction direction is a forward direction. The equation (11) is an average value of the vertical components of the motion vector of each block (a block referring across the reduced slice boundary) when the prediction direction is a backward direction. In the equations (10) and (11), the symbol “i” indicates the position of a line in which a block is included. For example, when the line of the block is the line 10 illustrated in FIG. 30, “0” is set to i. The “CTBNum” indicates the number of blocks referring across the reduced slice boundary among blocks included in a line. “ΣMV_Ver_L0(L1)_CTB[i][j][CTBNum′]” indicates the sum of vertical components of motion vectors of each block (a block referring across the reduced slice boundary) included in the line.

MV_Ver_L0[i]=ΣMV_Ver_L0_CTB[i][CTBNum′]/CTBNum′ (10)

MV_Ver_L1[i]=ΣMV_Ver_L1_CTB[i][CTBNum′]/CTBNum′ (11)

Subsequently, other processes of the controller 360 will be described. The controller 360 may calculate the quantization parameter QP′ using “CTBNum” described above. For example, when calculating the quantization parameter QP′ based on the equation (3), the controller 360 calculates “QP_Offset” based on the equation (12). The “CTBNum” included in the equation (12) indicates the number of blocks included in a line. By using “QP_Offset” in the equation (12), as the number of “blocks referring across the reduced slice boundary” included in the line increases, a quantization is performed with a smaller quantization parameter QP′.

QP_Offset=Min(MaxVal,6*(SAD_Sum1)/(SAD_sum2*2*2))*CTBNum′/CTBNum (12)

In the equation (12), “SAD_Sum1” is the sum of SAD1 of each block (a block referring across the reduced slice boundary) included in a preferential object line on the image information. The “SAD_Sum2” is the sum of SAD2 of each block (a block referring across the reduced slice boundary) included in a preferential object line on the reduced image information. The “SAD_Sum2” and “SAD_Sum1” are calculated by the following equations (12a) and (12b).

SAD_Sum2[i]=ΣSAD2[i][CTBNum′] (12a)

SAD_Sum1[i]=ΣSAD1[i][CTBNum′] (12b)

Although the encoding devices 100 to 300 have been described in the first to third embodiments, a processing of an encoding device is not limited to the processing of the encoding devices 100 to 300. Hereinafter, other processes of the encoding device will be described. For convenience of explanation, descriptions will be made with reference to FIG. 28.

For example, in the case of further reducing the processing load of the encoding device 300 that is performing a temporal direction hierarchical encoding, the determination unit 350 and the controller 360 determine whether a preferential object is given in the unit of SOP.

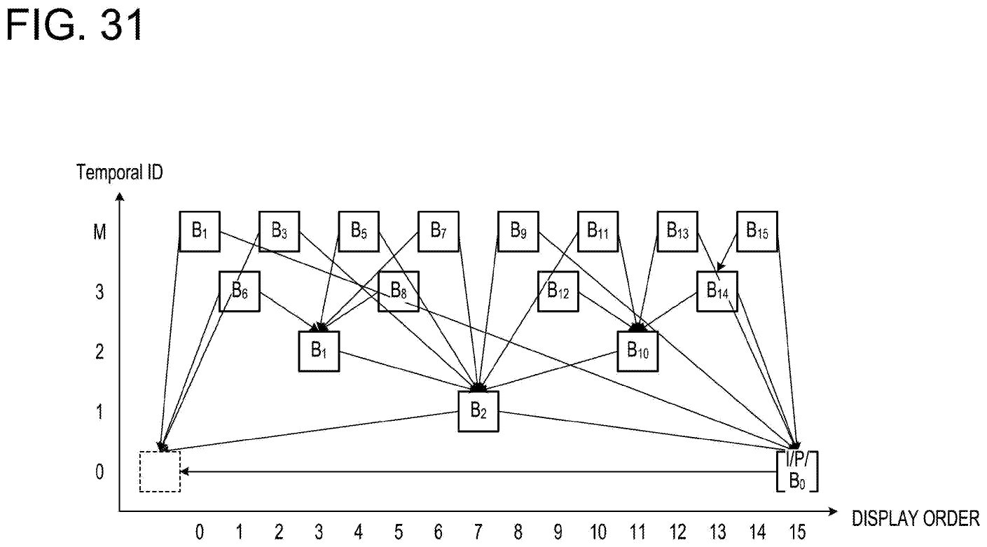

FIG. 31 is a view for explaining another processing of the encoding device. FIG. 31 illustrates an example of SOP (Structure Of Pictures) of the temporal direction hierarchical encoding specified in ARIB STD-B32. The SOP is a unit that describes the encoding order and the reference relationship of each AU when performing the temporal direction hierarchical coding introduced in HEVC. In FIG. 31, the vertical axis represents a TID (Temporary Identification), and the horizontal axis represents a display order. A subscript in a B picture indicates the order of encoding (or decoding). An arrow indicates the reference relationship. For example, in a “B3” picture, two arrows indicate that the “B3” picture is encoded with reference to either an “I” (or “P” or “B0”) picture or a “B2” picture. Similarly, a “B5” picture is encoded with reference to either a “B4” picture or the “B2” picture.

As can be seen from FIG. 31, an upper hierarchical picture has a longer reference distance, and a large distortion is more likely to occur in the picture in a wide range. As a TID number increases, a distance to the reference picture becomes shorter, and it may be estimated that the reference across a slice decreases. The upper hierarchical picture (e.g., the B0 picture of TID0) is the root of the hierarchical reference structure. When the image quality deterioration of this picture may be improved, the propagation of boundary deterioration to other pictures may be suppressed.

Therefore, the reduced image encoding unit 340 of the encoding device 300 calculates statistical information of the reduced slice boundary based on the picture B0 of TID0 in the unit of SOP and stores the statistical information in a storage area of the determination unit 350. Based on the statistical information stored in the storage area, the determination unit 350 determines whether each block of the picture B0 is a preferential object picture, and the controller 360 identifies the quantization parameter of each block.

When encoding pictures other than the picture B0, the encoding device 300 quantizes the blocks by calculating a quantization parameter which is obtained by giving a weight in which a TID number is considered to the quantization parameter of each block of the picture B0.

For example, it is assumed that the quantization parameter of “any block X” to be a preferential object of the picture B0 is a quantization parameter QP_{B0}. In this case, a quantization parameter QP_{B} of a block at the same position as that of the block X in another picture is calculated by the following equation (13). The symbol “W” included in the equation (13) is a weight considering the TID number. The smaller the TID number, the smaller the value of K. The symbol “K” is a numerical value smaller than 1.

QPB=QPB0×W (13)

That is, when the quantization parameter for each block of the picture B0 is determined, the quantization parameter for each picture of another picture is also determined. This makes it possible to further reduce the processing load of the encoding device 300.

The encoding units in the encoding devices according to the above embodiments are implemented by different processors. Other components in the encoding devices according to the above embodiments may be implemented by different processors, or several components may be implemented by a single processor. These processors may implement processing functions by executing programs stored in a memory, or may be circuits that incorporate processing functions. The processor may be, for example, a central processing unit (CPU), a micro processing unit (MPU), an application specific integrated circuit (ASIC), a field programmable gate array (FPGA), or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An encoder comprising:
a plurality of first processors each configured to
encode one of a plurality of slices obtained by dividing image information; and
a second processor configured to:
generate reduced image information by reducing the image information;
determine that a first block is a preferential object block when it is determined, based on a direction of a motion vector of the first block, that the first block is a block to be encoded with reference to a block included in a second reduced slice adjacent to a first reduced slice among a plurality of reduced slices obtained by dividing the reduced image information, the first block being included in the first reduced slice; and
perform, when it is determined that the first block is a preferential object block, a control to reduce a first quantization parameter used by one of the plurality of first processors to encode a block corresponding to the first block among a plurality of blocks included in a first slice corresponding to the first reduced slice.

2. The encoder according to claim 1, wherein
the second processor is further configured to:
determine that the first block is a preferential object block when the first block is a block to be encoded by an inter prediction, when the first block is a block located at an upper end of the first reduced slice, and when a magnitude of a vertical component of the motion vector of the first block is less than 0.

3. The encoder according to claim 1, wherein
the second processor is further configured to:
determine that the first block is a preferential object block when the first block is a block to be encoded by an inter prediction, when the first block is a block located at a lower end of the first reduced slice, and when a magnitude of a vertical component of the motion vector of the first block is more than 0.

4. The encoder according to claim 1, wherein
the second processor is further configured to:
determine that the first block is a preferential object block when the first block is a block to be encoded by an intra prediction and when the first block is a block located at an upper end of the first reduced slice.

5. The encoder according to claim 1, wherein
the second processor is further configured to:
perform, when the first block is to be encoded by a bidirectional prediction in which the first block is encoded with reference to a second block in a forward direction and a third block in a backward direction, a control to make the first quantization parameter smaller than a second quantization parameter in a case where the second block or the third block is not a preferential object block.

6. The encoder according to claim 4, wherein
the second processor is further configured to:
change the first quantization parameter based on the direction of the intra prediction of the first block when the first block is a block to be encoded by the intra prediction.

7. The encoder according to claim 1, wherein
the second processor is further configured to:
change the first quantization parameter based on a prediction error of the first block and a prediction error of a block corresponding to the first block among the plurality of blocks included in the first slice.

8. The encoder according to claim 1, wherein
the second processor is further configured to:
determine whether each of second blocks included in a line of a boundary of the first reduced slice is a preferential object block based on a direction of a motion vector of each of the second blocks.

9. The encoder according to claim 8, wherein
the second processor is further configured to:
change the first quantization parameter based on a number of blocks determined to be preferential object blocks among the second blocks.

10. The encoder according to claim 1, wherein
the second processor is further configured to:
change the first quantization parameter based on a hierarchy of image information including the first block when each of the first processors performs a temporal direction hierarchical encoding.

11. A method for encoding, the method comprising:
generating, by a computer, reduced image information by reducing image information;
determining that a first block is a preferential object block when it is determined, based on a direction of a motion vector of the first block, that the first block is a block to be encoded with reference to a block included in a second reduced slice adjacent to a first reduced slice among a plurality of reduced slices obtained by dividing the reduced image information, the first block being included in the first reduced slice; and
performing, when it is determined that the first block is a preferential object block, a control to reduce a first quantization parameter used by one of a plurality of first processors to encode a block corresponding to the first block among a plurality of blocks included in a first slice corresponding to the first reduced slice, the plurality of first processors each encoding one of a plurality of slices obtained by dividing the image information.

12. The method according to claim 11, further comprising:
determining that the first block is a preferential object block when the first block is a block to be encoded by an inter prediction, when the first block is a block located at an upper end of the first reduced slice, and when a magnitude of a vertical component of the motion vector of the first block is less than 0.

13. The method according to claim 11, further comprising:
determining that the first block is a preferential object block when the first block is a block to be encoded by an inter prediction, when the first block is a block located at a lower end of the first reduced slice, and when a magnitude of a vertical component of the motion vector of the first block is more than 0.

14. The method according to claim 11, further comprising:
determining that the first block is a preferential object block when the first block is a block to be encoded by an intra prediction and when the first block is a block located at an upper end of the first reduced slice.

15. The method according to claim 11, further comprising:
performing, when the first block is to be encoded by a bidirectional prediction in which the first block is encoded with reference to a second block in a forward direction and a third block in a backward direction, a control to make the first quantization parameter smaller than a second quantization parameter in a case where the second block or the third block is not a preferential object block.

16. The method according to claim 14, further comprising:
changing the first quantization parameter based on the direction of the intra prediction of the first block when the first block is a block to be encoded by the intra prediction.

17. The method according to claim 11, further comprising:
changing the first quantization parameter based on a prediction error of the first block and a prediction error of a block corresponding to the first block among the plurality of blocks included in the first slice.

18. The method according to claim 11, further comprising:
determining whether each of second blocks included in a line of a boundary of the first reduced slice is a preferential object block based on a direction of a motion vector of each of the second blocks.

19. The method according to claim 18, further comprising:
changing the first quantization parameter based on a number of blocks determined to be preferential object blocks among the second blocks.

20. The method according to claim 11, further comprising:
changing the first quantization parameter based on a hierarchy of image information including the first block when each of the first processors performs a temporal direction hierarchical encoding.
